(19) United States
(12) Patent Application Publication
(10) Pub. No.: US 2026/0342694 A1
(43) Pub. Date: Oct. 29, 2026

(54) Methods, Apparatus and Computer-Readable Media Related to Quality of Experience Information in a Communications Network

(71) Applicant: Telefonaktiebolaget LM Ericsson (publ), Stockholm (SE)

(72) Inventors: Luca Lunardi, Genova (IT); Filip Barac, Huddinge (SE); Johan Rune, Lidingö (SE); Cecilia Eklöf, Täby (SE)

(21) Appl. No.: 19/100,735

(22) PCT Filed: Aug. 2, 2023
(86) PCT No.: PCT/SE2023/050771

§ 371 Date: Feb. 3, 2025

Related U.S. Application Data
(60) Provisional application No. 63/395,139, filed on Aug. 4, 2022.

(51) Int. Cl. H04L 41/5067; H04W 76/19; H04W 76/20

(52) U.S. Cl. CPC H04L 41/5067; H04W 76/19; H04W 76/20

(57) ABSTRACT

A method is performed by a user equipment. The method comprises, upon transitioning to a connected state, connecting to a first radio access network (RAN) node of a communication network. The method further comprises transmitting, to the communication network, information related to one or more quality-of-experience measurement sessions configured at the user equipment. The one or more QoE measurement sessions were configured at the user equipment during a previous instance of the user equipment in the connected state.

### TECHNICAL FIELD

Embodiments of the present disclosure relate to methods, apparatus and computer-readable media relating to communication networks, and particularly to quality of experience information in a communications network.

### BACKGROUND

Overview of the QoE framework

### “Regular” QoE

Quality of Experience (QoE) measurements, also referred to as “application layer measurements”, have been specified for Long-Term Evolution (LTE) and Universal Mobile Telecommunications System (UMTS) and are being specified for New Radio (NR) in the 3rd Generation Partnership Project (3GPP) release 17. The purpose of the application layer measurements is to measure the end user experience when using certain applications. Currently QoE measurements for streaming services and for Mobility Telephony Service for Internet Protocol (IP) Multimedia Subsystem (IMS) (MTSI) services are supported. For NR, it is likely that at least Virtual Reality (VR) will be added to the list of services for which QoE measurements are specified and supported.

The solutions in LTE and UMTS are similar with the overall principles as follows. Quality of Experience Measurement Collection (QMC) enables configuration of application layer measurements in the User Equipment (IE) and transmission of QoE measurement result files (commonly referred to as QoE reports) to the network by means of Radio Resource Control (RRC) signalling. An application layer measurement configuration (also called QoE measurement configuration or QoE configuration) that the the Radio Access Network (RAN) receives from the Operations, Administration and Maintenance (OAM) system or the Core Network (CN) is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP release 17 a new study item for “Study on NR QoE management and optimizations for diverse services” for NR has been approved and concluded. The specification work for 3GPP release 17 is still ongoing. The purpose of the study item is to study solutions for QoE measurements in NR. QoE management in NR will not just collect the quality of experience parameters of streaming services but also consider the typical performance requirements of diverse services (e.g. Augmented Reality (AR)/VR and Ultra-Reliable Low Latency Communications (URLLC), of which at least VR will be covered in 3GPP release 17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity the collected measurement results (i.e. the QoE reports) should be sent to (often referred to as a MCE, spelled out as Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE and are placed in a “container” which the network entities handling it, e.g., forwarding it to the UE, as well as the UE Access Stratum, cannot interpret and do not try to read. The currently specified service types are MTSI and streaming service (DASH), and in 3GPP release 17, service type VR will be added and QoE measurements on Multicast and Broadcast Services (MBS) will be specified in 3GPP release 18. An area scope is defined in terms of cells or network related areas. In UMTS, an area scope is defined as either a list of cells, a list of routing areas, or a list of tracking areas. In LTE, an area scope is defined as either a list of cells or a list of tracking areas. In NR, an area scope will be defined as either a list of cells or a list of tracking areas.

QoE, and in particular QoE configuration, comes in two flavors: management-based QoE configuration and signaling-based QoE configuration. In both cases the QoE configuration originates in the OAM system or some other administrational entity, e.g., dealing with customer satisfaction. All of these entities are in this document referred to as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, e.g., because the user of the UE has filed a complaint. The OAM system sends the s-based QoE configuration to the Home Subscriber Server (HSS) (in Evolved Packet System (EPS)/LTE) or Unified Data Management (UDM) (in 5GS/NR), which forwards the QoE configuration to the UE's current core network node (CN), e.g., a Mobility Management Entity (MME) in EPS/LTE or an Access & Mobility Management Function (AMF) in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms. In NR, and possibly in LTE, a globally unique QoE reference (formed of Mobile Country Code (MCC)+Mobile Network Code (MNC)+QoE Measurement Collection (QMC) ID, where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting can be configured to be periodic or only sent at the end of an application session. Furthermore, the RAN can instruct the UE to pause QoE reporting, e.g., in case the cell/gNB is in a state of overload.

The RAN is not aware of when an application session with an associated QoE measurement session is ongoing, and the UE Access Stratum is also not automatically aware of this. To alleviate this session start/stop indications will be introduced, which will be sent from the application layer in the UE to the UE AS and from the UE AS to the RAN. A session stop indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, which as previously mentioned is commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE)

An extension of the QoE framework, which has been studied for 3GPP release 17 and which is currently being specified in 3GPP, is the concept of RAN visible QoE (RVQoE). The regular QoE reports are intended for the MCE, which is an entity outside the RAN, e.g., a part of the OAM system, and the RAN cannot read the QoE reports (at least not according to specification, although gNB/eNB implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

### AT Commands

AT commands are used for communication between the AS (radio) layer and the application layer in the UE. The AT commands are defined in 3GPP TS 27.007 version 17.3.0.

### QoE Measurement in Legacy Systems

### QoE Measurement in UMTS Terrestrial Radio Access Network (UTRAN)

### UTRAN—Application Layer Measurement Capabilities

According to 3GPP TS 25.331, UTRAN can request the ULE (using a LUE Capability Enquiry RRC message) to report its capability, as shown in Error! Reference source not found., which illustrates a UE capability enquiry procedure in UTRAN.

In response, the UE can provide information about its capability using the LUE Capability Information RRC message as shown in Error! Reference source not found., which illustrates the transmission of UE capability information in UTRAN

The UE can indicate support for QoE measurement and reporting in the LUE Capability Information message. The relevant indications are included in the “Measurement capability” information element (IE), which in turn is included in the “UE radio access capability” IE, which is included in the LUE Capability Information message. The relevant definitions are copied from 3GPP TS 25.331 version 16.1.0 below.

The UE Capability Information message:

| Information | | | Type and | Semantics |
|---|---|---|---|---|
| Element/Group name | Need | Multi | reference | description |
| Message Type | MP | | Message | |
| | | | Type | |
| UE information elements | | | | |
| RRC transaction | OP | | RRC | |
| identifier | | | transaction | |
| | | | identifier | |
| | | | 10.3.3.36 | |
| Integrity check info | CH | | Integrity | Integrity check |
| | | | check info | info is included |
| | | | 10.3.3.16 | if integrity |
| | | | | protection |
| | | | | is applied |
| UE radio access | OP | UE radio access | | |
| capability | | capability 10.3.3.42 | | |
| UE radio access | OP | UE radio access | | |
| capability extension | | capability extension | | |
| | | 10.3.3.42a | | |
| Other information elements | | | | |
| UE system specific | OP | 1 to | | |
| capability | | <maxInterSysMessages> | | |
| >Inter-RAT UE radio | MP | Inter-RAT | | |
| access capability | | UE radio access | | |
| | | capability 10.3.8.7 | | |

The “UE radio access capability” IE:

| | | | | | |
|---|---|---|---|---|---|
| Information | | | | | |
| Element/ | | | Type and | Semantics | |
| Group name | Need | Multi | reference | description | Version |

.
.
.

| | | |
|---|---|---|
| Measurement | OP | Measurement |
| capability | | capability |
| | | 10.3.3.21 |

.
.
.

The “Measurement capability” IE:

| | | | | | |
|---|---|---|---|---|---|
| Information | | | | | |
| Element/ | | | Type and | Semantics | |
| Group name | Need | Multi | reference | description | Version |

.
.
.

| | | | | |
|---|---|---|---|---|
| QoE Measurement | CV- | Enumerated | TRUE means | REL-14 |
| Collection for | not_iRAT_HoInfo | (TRUE) | that the UE | |
| streaming services | | | supports QoE | |
| | | | Measurement | |
| | | | Collection for | |
| | | | streaming services. | |
| QoE Measurement | CV- | Enumerated | TRUE means | REL-15 |
| Collection for | not_iRAT_HoInfo | (TRUE) | that the UE | |
| MTSI services | | | supports QoE | |
| | | | Measurement | |
| | | | Collection for | |
| | | | MTSI services. | |

.
.
.

### UTRAN—QoE Measurement Configuration—RRC Signaling

To configure QoE measurement in the UE, the UTRAN can send a Measurement Control RRC message containing the “Application layer measurement configuration” IE. FIG. 1 illustrates a measurement control procedure in a normal UTRAN case.

The relevant definitions are copied from 3GPP TS 25.331 version 16.1.0 below.

The Measurement Control message:

| | | | | | |
|---|---|---|---|---|---|
| Information | | | | | |
| Element/ | | | Type and | Semantics | |
| Group name | Need | Multi | reference | description | Version |

.
.
.

| | | |
|---|---|---|
| >Application | Application | REL-14 |
| layer | layer | |
| measurement | measurement | |
| configuration | configuration | |
| | 10.3.7.143 | |

.
.
.

The “Application layer measurement configuration” IE:

| | | | | | |
|---|---|---|---|---|---|
| Information | | | | | |
| Element/ | | | Type and | Semantics | |
| Group name | Need | Multi | reference | description | Version |

| | | | |
|---|---|---|---|
| Container for | MP | Octet string | REL-14 |
| application | | (1 . . . 1000) | |
| layer | | | |
| measurement | | | |
| configuration | | | |
| Service type | MP | Enumerated | REL-15 |
| | | (QoEStreaming, | |
| | | QoEMTSI) | |

### UTRAN—QoE Measurement Reporting—RRC Signaling

The UE can send QoE measurement results via UTRAN to the Collecting Entity using the “Measurement Report” RRC message including the “Application layer measurement reporting” IE. FIG. 2 illustrates a measurement report procedure in a normal UTRAN case.

The UE may also perform Cell Update to indicate that an application layer measurement report is available in the UE.

SRB4 shall be used for the Measurement Report message carrying the “Application layer measurement reporting” IE.

The relevant definitions are copied from 3GPP TS 25.331 version 16.1.0 below.

The Measurement Report message:

| | | | | | |
|---|---|---|---|---|---|
| Information | | | | | |
| Element/ | | | Type and | Semantics | |
| Group name | Need | Multi | reference | description | Version |

.
.
.

| | | | |
|---|---|---|---|
| Application | OP | Application | REL-14 |
| layer | | layer | |
| measurement | | measurement | |
| reporting | | reporting | |
| | | 10.3.7.144 | |

The “Application layer measurement reporting” IE:

| | | | | | |
|---|---|---|---|---|---|
| Information | | | | | |
| Element/ | | | Type and | Semantics | |
| Group name | Need | Multi | reference | description | Version |

| | | | |
|---|---|---|---|
| Container for | MP | Octet string | REL-14 |
| application | | (1 . . . 8000) | |
| layer | | | |
| measurement | | | |
| reporting | | | |
| Service type | MP | Enumerated | REL-15 |
| | | (QoEStreaming, | |
| | | QoEMTSI) | |

The Cell Update message:

| | | | | | |
|---|---|---|---|---|---|
| Information | | | | | |
| Element/ | | | Type and | Semantics | |
| Group name | Need | Multi | reference | description | Version |

.
.
.

| | | |
|---|---|---|
| Cell update | MP | Cell update |
| cause | | cause |
| | | 10.3.3.3 |

.
.
.

| | | | | |
|---|---|---|---|---|
| Logged Meas | OP | Enumerated | Indicates | REL-10 |
| Available | | (TRUE) | the UE has | |
| | | | logged | |
| | | | measurements | |
| | | | to report to | |
| | | | the network | |

.
.
.

The “Cell update cause” IE:

| | | | | | |
|---|---|---|---|---|---|
| Information | | | | | |
| Element/ | | | Type and | Semantics | |
| Group name | Need | Multi | reference | description | Version |

| | | | | |
|---|---|---|---|---|
| Cell update | MP | Enumerated (cell | | |
| cause | | reselection, | | |
| | | periodical cell | | |
| | | update, uplink | | |
| | | data transmission, | | |
| | | paging response, | | |
| | | re-entered service | | |
| | | area, radio link | | |
| | | failure, RLC | | |
| | | unrecoverable error, | | |
| | | cellUpdateCause-ext) | | |
| Cell update | OP | Enumerated (MBMS | | REL-6 |
| cause Ext | | reception, MBMS ptp | | |
| | | RB request, dummy, | | |
| | | cellUpdateCause-ext2) | | |
| Cell update | OP | Enumerated (application | Three spare | REL-14 |
| cause Ext2 | | layer measurement | values are | |
| | | report available) | needed. | |

### QoE Measurement in Evolved UTRAN (E-UTRAN)

### E-UTRAN—Application Layer Measurement Capabilities

For E-UTRAN, the UE capability transfer is used to transfer UE radio access capability information from the UE to E-UTRAN. FIG. 3 illustrates a UE capability transfer procedure involving E-UTRAN.

The UE-EUTRA-Capability IE is used to convey the E-UTRA UE Radio Access Capability Parameters and the Feature Group Indicators for mandatory features to the network.

In the response message “UECapabilityInformation”, the UE can include the “UE-EUTRA-Capability” IE. The “UE-EUTRA-Capability” IE may include the “UE-EUTRA-Capability-v1530-IEs” IE which can be used by the UE to indicate whether the UE supports QoE Measurement Collection for streaming services and/or MTSI services. The relevant ASN.1 code in the ASN.1 definition for UE-EUTRA-Capability IE is indicated below (where most of the ASN.1 code in the UE-EUTRA-Capability IE definition is omitted for clarity).

| | |
|---|---|
| -- ASN1START | |
| : | |
| : | |
| : | |
| : | |
| UE-EUTRA-Capability-v1530-IEs ::= SEQUENCE { | |
| measParameters-v1530 | MeasParameters-v1530 |
| OPTIONAL, | |
| OtherParameters-v1530 | Other-Parameters-v1530 |
| OPTIONAL, | |
| neighCellSI-AcquisiionParameters-v1530 | NeighCellSI- |
| AcquisitionParameters-v1530 OPTIONAL, | |
| mac-Parameters-v1530 | MAC-Parameters-v1530 |
| OPTIONAL, | |
| phyLayerParameters-v1530 | PHYLayerParameters-v1530 |
| OPTIONAL, | |
| rf-Parameters-v1530 | RF-Parameters-v1530 |
| OPTIONAL, | |
| pdcp-Parameters-v1530 | PDCP-Parameters-v1530 |
| OPTIONAL, | |
| ue-CategoryDL-v1530 | INTEGER (22..26) |
| OPTIONAL, | |
| ue-BasedNetwPerfMeasParameters-v1530 | UE- |
| BasedNetwPerfMeasParameters-v1530 OPTIONAL, | |
| rlc-Parameters-v1530 | RLC-Parameters-v1530 |
| OPTIONAL, | |
| sl-Parameters-v1530 | SL-Parameters-v1530 |
| OPTIONAL, | |
| extendedNumberOfDRBa-r15 | ENUMERATED |
| {supported} OPTIONAL, | |
| reducedCP-Latency-r15 | ENUMERATED |
| {supported} OPTIONAL, | |
| laa-Parameters-v1530 | LAA-Parameters-v1530 |
| OPTIONAL, | |
| ue-CategoryUL-v1530 | INTEGER (22..26) |
| OPTIONAL, | |
| fdd-Add-UE-EUTRA-Capabilities-v1530 | UE-EUTRA- |
| Capabilty AddXDD-Mode-v1530 OPTIONAL, | |
| tdd-Add-UE-EUTRA-Capabilities-v1530 | UE-EUTRA- |
| Capabilty AddXDD-Mode-v1530 OPTIONAL, | |
| nonCriticalExtension | EU-EUTRA-Capability- |
| v1540-IEs OPTIONAL | |
| } | |
| : | |
| : | |
| : | |
| : | |
| MeasParameters-v1530 ::= SEQUENCE { | |
| qoe-MeaReport-r15 | ENUMERATED |
| {supported} OPTIONAL, | |
| qoe-MTSI-MeaReport-r15 | ENUMERATED |
| {supported} OPTIONAL, | |
| ca-IdleModeMeasurements-r15 | ENUMERATED |
| {supported} OPTIONAL, | |
| ca-IdleModeValidityArea-r12 | ENUMERATED |
| {supported} OPTIONAL, | |
| heightMeas-r15 | ENUMERATED |
| {supported} OPTIONAL, | |
| multipleCellsMeasExtension-r15 | ENUMERATED |
| {supported} OPTIONAL, | |
| } | |
| : | |
| : | |
| : | |
| -- ASN1STOP | |

| | FDD/TDD |
|---|---|
| UE-EUTRA-Capability field descriptions | diff |
| . | — |
| . | |
| . | |
| qoe-MeasReport | — |
| Indicates whether the UE supports QoE | |
| Measurement Collection for streaming services. | |
| qoe-MTSI-MeasReport | |
| Indicates whether the UE supports QoE | |
| Measurement Collection for MTSI services. | |
| . | — |
| . | |
| . | |

### E-UTRAN—QoE Measurement Configuration Setup and Release—RRC Signaling

The RRCConnectionReconfiguration message is used to reconfigure the UE to setup or release the UE for Application Layer measurements. This is signaled in the measConfigAppLayer-r15 IE within the OtherConfig IE.

The setup includes the transparent container measConfigAppLayerContainer IE which specifies the QoE measurement configuration for the application of interest and the serviceType IE which indicates the Application (or service) for which the QoE measurements are being configured. Supported services are streaming and MTSI.

The relevant parts of the ASN.1 code and field descriptions for the OtherConfig IE is copied from 3GPP TS 36.331 version 16.6.0 below (with the fields/parameters that are irrelevant in the context of QoE omitted for clarity).

```
    -- ASN1START
    OtherConfig-r9 ::= SEQUENCE{
        :
        :
        :
        :
      [[ measConfigAppLayer-r15  Choice{
          release  NULL,
          setup  SEQUENCE{
        measConfigAppLayerContainer-r15  OCTET
STRING (SIZE(1..1000)),
        serviceType-r15
ENUMERATED {qoe, qoemtsi, spare6,
        spare5, spare4, spare3,
        spare2, spare1
          }
        } OPTIONAL, -- Need ON
        :
        :
        :
        :
    }
        :
        :
        :
    -- ASN1STOP
```

OtherConfig field descriptions

.
.
.
measConfigAppLayerContainer
The field contains configuration of application layer measurements,
see Annex L (normative) in TS 26.247 [90] and clause 16.5 in
TS 26.114 [99].
.
.
.

The following is the procedural text related to the OtherConfig IE (i.e. when the UE receives an RRCConnectionReconfiguration message including an OtherConfig IE) and QoE measurement configuration.

The UE shall:
:
:
:
1> if the received otherConfig includes the measConfigAppLayer:
   2> if measConfigAppLayer is set to setup:
      3> forward measConfigAppLayerContainer to upper layers considering the serviceType;
      3> consider itself to be configured to send application layer measurement report in accordance with 5.6.19;
   2> else:
      3> inform upper layers to clear the stored application layer measurement configuration;
      3> discard received application layer measurement report information from upper layers;
      3> consider itself not to be configured to send application layer measurement report.

### E-UTRAN—Application Layer Measurement Reporting

The purpose of the “Application layer measurement reporting” procedure described in 3GPP TS 36.331 version 16.6.0 and shown below is to transfer the application layer measurement report to E-UTRAN, so that the E-UTRAN can forward the report to the O&M system, e.g. to a Measurement Collector Entity (MCE) or a Trace Collector Entity (TCE). FIG. 4 illustrates application layer measurement reporting in E-UTRAN.

A UE capable of application layer measurement reporting in RRC_CONNECTED state may initiate the procedure when configured with application layer measurement, i.e. when the measConfigAppLayer IE has been configured by E-UTRAN. For this purpose, the UE uses the MeasReportAppLayer RRC message, which contains the measReportAppLayerContainer IE and the serviceType IE.

According to 3GPP TS 36.331 version 16.6.0, upon initiating the application layer measurement reporting procedure, the UE shall:
1> if configured with application layer measurement, and SRB4 is configured, and the UE has received application layer measurement report information from upper layers:
   2> set the measReportAppLayerContainer in the MeasReportAppLayer message to the value of the application layer measurement report information;
   2> set the service Type in the MeasReportAppLayer message to the type of the application layer measurement report information;
   2> submit the MeasReportAppLayer message to lower layers for transmission via SRB4.

In ASN.1 code (with associated field descriptions), the MasReportAppLayer message is defined as follows in 3GPP TS 36.331 version 16.6.0:

| -- ASN1START | | |
|---|---|---|
| MeasReportAppLayer-r15 ::= | SEQUENCE { | |
| criticalExtensions | CHOICE { | |
| measReportAppLayer-r15 | | |
| MeasReportAppLayer-r15-IEs, | | |
| criticalExtensionsFuture | SEQUENCE { } | |
| } | | |
| } | | |
| MeasReportAppLayer-r15-IEs ::= | SEQUENCE { | |
| measReportAppLayerContainer-r15 | OCTET | STRING |
| (SIZE(1..8000)) OPTIONAL, | | |
| serviceType-r15 | ENUMERATED | {qoe, |
| qoemtsi, | spare6, | spare5, |
| | spare4, spare3, spare2, | |
| | spare1} | OPTIONAL, |
| nonCriticalExtension | MeasReportAppLayer-v1590-IEs | |
| OPTIONAL | | |
| } | | |
| MeasReportAppLayer-v1590-IEs := | SEQUENCE { | |
| lateNonCriticalExtension | OCTET STRING | |
| OPTIONAL, | | |
| nonCriticalExtension | SEQUENCE { } | |
| OPTIONAL | | |
| } | | |
| -- ASN1STOP | | |

Meas ReportAppLayer field descriptions

measReportAppLayerContainer
The field contains container of application layer measurements, see Annex L (normative)
in TS 26.247 [90] and clause 16.5 in TS 26.114 [99].
serviceType
Indicates the type of application layer measurement. Value qoe indicates Quality of
Experience Measurement Collection for streaming services, value qoemtsi indicates Quality
of Experience Measurement Collection for MTSI.

### UE Application Layer Measurement Configuration

For signaling based QoE configuration, the configuration is signaled to the RAN (eNB) from the MME using the control plane protocol for the S1 interface, i.e. S1AP, which is specified in 3GPP TS 36.413 version 16.7.0.

The “UE Application layer measurement configuration” IE defines configuration information for the QoE Measurement Collection (QMC) function. It is described in section 9.2.1.128 of 3GPP TS 36.413 version 16.7.0 as follows (note that this IE is included in the Trace Activation IE, which also, among other parameters, includes the Trace Collection Entity IP Address IE):

| IE/Group | | | IE type and | | | Assigned |
|---|---|---|---|---|---|---|
| Name | Presence | Range | reference | Semantics description | Criticality | Criticality |
| Container for | M | | Octet string | Indicates | — | — |
| application | | | (1..1000) | application layer | | |
| layer | | | | measurement | | |
| measurement | | | | configuration, | | |
| configuration | | | | see Annex L in [43]. | | |
| CHOICE | M | | | | — | — |
| Area Scope | | | | | | |
| of QMC | | | | | | |
| >Cell | | | | | | — |
| based | | | | | | |
| >>Cell ID | | 1..<maxnoofCellIDforQMC> | | | | — |
| List for | | | | | | |
| QMC | | | | | | |
| >>>E-CGI | M | | 9.2.1.38 | | — | — |
| >TA based | | | | | | — |
| >>TA List | | 1..<maxnoofTAforQMC> | | | | — |
| for QMC | | | | | | |
| >>>TAC | M | | 9.2.3.7 | The TAI is | — | — |
| | | | | derived using | | |
| | | | | the current serving | | |
| | | | | PLMN. | | |
| >TAI based | | | | | — | — |
| >>TAI List | | 1..maxnoofTAforQMC> | | | — | — |
| for QMC | | | | | | |
| >>>TAI | M | | 9.2.3.16 | | — | — |
| >PLMN | | | | | | — |
| area based | | | | | | |
| >>PLMN | | 1..<maxnoofPLMNforQMC> | | | | — |
| List for | | | | | | |
| QMC | | | | | | |
| >>>PLMN | M | | 9.2.3.8 | | — | — |
| Identity | | | | | | |
| Service Type | M | | ENUMERATED | This IE | — | — |
| | | | (QMC for | indicates the | | |
| | | | streaming service, | service type of UE | | |
| | | | QMC for MTSI | application layer | | |
| | | | service, ...) | measurements. | | |

| Range bound | Explanation |
|---|---|
| maxnoofCellIDforQMC | Maximum no. of Cell ID subject for QMC |
| | scope. Value is 32. |
| maxnoofTAforQMC | Maximum no. of TA subject for QMC scope. |
| | Value is 8. |
| maxnoofPLMNforQMC | Maximum no. of PLMNs in the PLMN list for |
| | QMC scope. Value is 16. |

### Area Scope for QoE Measurements

According to 3GPP TS 28.405 version 16.0.0, the area scope parameter defines the area in terms of cells or Tracking Area/Routing Area/Location Area where the QMC shall take place. If the parameter is not present, the QMC shall be done throughout the Public Land Mobile Network (PLMN) specified in PLMN target.

The area scope parameter in UMTS is either:
A list of cells, identified by Cell Global Identity (CGI). Maximum 32 CGI can be defined.
A list of Routing Area, identified by Routing Area Identification (RAI). Maximum of 8 RAIs can be defined.
A list of Location Area, identified by Location Area Identification (LAI). Maximum of 8 LAIs can be defined.

The area scope parameter in LTE is either:
A list of cells, identified by E-UTRAN-CGI. Maximum 32 CGI can be defined.
A list of Tracking Area, identified by Tracking Area Code (TAC). Maximum of 8 TAC can be defined.

For NR, the area scope parameter will be either:
A list of cells, or
A list of tracking areas.

The parameter is mandatory if area based QMC is requested.

### RRC_INACTIVE State

In 5G/NR, a UE may be in either of three different RRC states: RRC_CONNECTED state, RRC_INACTIVE state and RRC_IDLE state. RRC_CONNECTED state is the state normally used when the UE is actively communicating. RRC_INACTIVE state and RRC_IDLE state are designed to allow the UE to save energy compared to when the UE is in RRC_CONNECTED state.

RRC_IDLE state is the state in which the UE consumes the least energy (and the gNB saves resources by deleting the UE's state information, also known as the UE context), but it comes at the cost of comparatively long network access time (e.g., transition to RRC_CONNECTED state).

RRC_INACTIVE state has properties that put it in between the RRC_CONNECTED state and RRC_IDLE state.

The purpose of the RRC_INACTIVE state is to reduce the signaling overhead over the radio and network interface and to improve the UE access latency (compared to RRC_IDLE state) as well as the UE energy consumption. In this state, the Core Network (CN) still regards the UE as connected, thus the CN-RAN connection for the UE is kept active although the RRC connection between the gNB and the UE is suspended. The gNB which maintains the connection to the CN while the UE is in RRC_INACTIVE state is called the Anchor gNB. In order to reduce radio interface signaling at connection establishment, the UE context information is kept in the UE and in the Anchor gNB, which enables the UE to resume its RRC connection when it is paged or has Uplink (UL) data or signaling to send. When the CN has user data or control data to send to the UE, the data is sent to the Anchor gNB which then initiates paging of the UE (also known as RAN initiated paging).

In RRC_INACTIVE state, the UE can move around in a UE specific RAN Notification Area (RNA) without informing the network of its location within the RNA. When the UE leaves its configured RNA, the UE informs the network using RNA Update signaling in the form of an RRCResumeRequest message with the resumeCause IE set to “rna-Update”. If too long time elapses without communication between the UE and the network, the UE sends a periodic RNA Update (i.e. an RRCResumeRequest message with the resumeCause IE set to “rna-Update”) to the network, even if it has not left its configured RNA.

The gNB configures the UE's RNA when the gNB releases the UE from RRC_CONNECTED state to RRC_INACTIVE state, using an RRCRelease message. There are three different alternatives for how to configure a RNA for a UE:
A list of cells. The UE is provided with a list of (one or more) global cell IDs of the cells constituting the RNA.
A list of RAN Areas. The UE is provided a list of (one or more) RAN Area IDs, where a RAN Area ID consists of a RAN Area Code (RANAC) combined with a Tracking Area Code and a PLMN ID (i.e. the RANAC is unique within a Tracking Area). To enable RNA configuration using a list of RAN Areas, every cell should broadcast a RAN Area Code (which could optionally be absent in case the network does not use RAN Area based RNA configuration). A RAN Area consists of a subset (or all) of the cells of one Tracking Area.
A list of Tracking Areas. The UE is provided a list of (one or more) Tracking Area IDs, where a Tracking Area ID consists of a Tracking Area Code (TAC) combined with a PLMN ID.

A UE's RNA should not include areas outside the list of Tracking Areas the CN has configured for the UE, since crossing of this border would trigger the UE to send a Registration Request Non-Access Stratum (NAS) message to the CN with the “5GS registration type” IE set to “mobility registration updating” (i.e. the procedure referred to as Tracking Area Update in LTE).

The RAN may use either of the above configuration alternatives when configuring a RNA for a UE, and it may use different configuration methods for different UEs as well as for the same UE at different times, but it cannot mix different configuration alternatives in the same RNA configuration for a certain UE at the same time.

Upon an RNA Update (or other contact between the UE and the network), the RAN may configure a new RNA for the UE (e.g. if the UE has moved to a new cell) and if the UE has moved to a new gNB, the UE's context in the RAN is fetched from the old Anchor gNB to the new gNB. This is done using the XnAP messages RETRIEVE UE CONTEXT REQUEST and RETRIEVE UE CONTEXT RESPONSE. In addition, the RAN-CN connection for the UE is moved from the old Anchor gNB to the new gNB, which then becomes the new Anchor gNB. This is done using the NG Application Protocol (NGAP) messages PATH SWITCH REQUEST and PATH SWITCH REQUEST ACKNOWLEDGE.

When the RAN switches (i.e. releases) a UE from RRC_CONNECTED to RRC_INACTIVE state, the serving gNB (which becomes the Anchor gNB) allocates an identity referred to as the I-RNTI to the UE. The I-RNTI serves to identify both the Anchor gNB and the UE's context within the Anchor gNB when the UE's context is fetched from an old Anchor gNB to a new gNB.

When the UE wants to transit from the RRC_INACTIVE state to the RRC_CONNECTED state, due to reception of a page or due to arrival of pending UL data (i.e. data originating in the UE and put in an UL transmission buffer in the UE), the UE sends a request to resume the RRC connection (including the suspended radio bearers) containing its I-RNTI (this is the RRCResumeRequest message). The gNB receiving the request uses the included I-RNTI to fetch the UE's context from the old Anchor gNB (also known as “last serving gNB”), after which the RRC connection can be resumed. The new gNB then completes the resumption of the RRC connection (by sending an RRCResume message from the new gNB to the UE, which the UE responds to with an RRCResumeComplete message), and the UE context in the old Anchor gNB (last serving gNB) is deleted.

A UE in RRC_INACTIVE state is said to be “camping” on a cell in which it monitors relevant Downlink (DL) control signals, such as synchronization signals, system information and paging. An RRC_INACTIVE UE is assumed to follow the same cell reselection rules as a UE in RRC_IDLE state. Hence, the cell reselection information provided in the system information, which traditionally is used by UEs in RRC_IDLE state, applies to UEs in RRC_INACTIVE state too. This includes e.g. measurement thresholds, reselection thresholds, hysteresis parameters to avoid “ping-pong” reselection and potential cell-specific offsets. In addition, to control potential inter-frequency and/or inter-Radio Access Technology (RAT) cell reselection, the cell reselection related system information typically also contains frequency priorities and/or RAT priorities.

There currently exist certain challenge(s).

The current 3GPP standard specifications allow a UE to retain a QoE measurement configuration while the UE is in RRC_INACTIVE state. However, the standard specifications do not say anything about a possibility for the UE to perform QoE measurements in RRC_INACTIVE state, or about the information to provide to the network related to the period spent in RRC_INACTIVE state.

Note that, for example, a streaming application may have a buffer of video data that lasts several minutes. This means that a streaming session may well survive a significant period without communication, which may occur, e.g., when if the UE is temporarily released to RRC_INACTIVE state (or even RRC_IDLE state).

Furthermore, considering that an application session with an associated QoE measurement session may be ongoing when the UE is released to RRC_INACTIVE state, and may or may not end while the UE is in RRC_INACTIVE state, or a new application session with an associated QoE measurement session may be started while the UE is in RRC_INACTIVE state, there is a problem with the session status (ongoing or not ongoing) indication in the network. That is, since there is no communication between the UE and the network while the UE is in RRC_INACTIVE state, there is no way to ensure that the session status indication in the network is correct.

This implies a problem when the session status indication is transferred (in the RETRIEVE UE CONTEXT RESPONSE XnAP message in NR) from the anchor RAN node (i.e., the old RAN node, e.g. the old gNB) to the new RAN node (e.g. the new gNB) when the UE resumes the RRC connection in a new RAN node, since the status indication to the new RAN node may be incorrect, due to the above.

### SUMMARY

Certain aspects of the disclosure and their embodiments may provide solutions to these or other challenges.

One aspect of the disclosure seeks to address the problem described above by providing, from the UE to the network, information about the QoE measurement session(s) (e.g. ongoing, not ongoing, terminated, . . . ) during a passed RRC_INACTIVE period when the RRC connection is resumed (e.g., the UE sends this information to the new RAN node in which the UE resumes its RRC connection). If retention of a QoE configuration in RRC_IDLE state is enabled in future 3GPP releases, the solution may also be applicable in the case where the UE is released to RRC_IDLE state and later sets up a new RRC connection, possibly towards a new RAN node.

The session status information may be enriched or complemented with further related information, such as a list of session status changes that occurred during the period in RRC_INACTIVE (or RRC_IDLE) state, timestamps of the session status changes, or the duration of the period in RRC_INACTIVE (or RRC_IDLE) state.

Related information may also be transferred from an old RAN node to a new RAN node (e.g., in the case of RRC_INACTIVE state, from the anchor RAN node to the RAN node towards which the UE performs the RRC resume procedure), such as the latest known session status (which may be overridden by up to date session status information from the UE, timestamp of the time the UE was released to RRC_INACTIVE (or RRC_IDLE) state, and/or the latest reported value(s) of certain RVQoE metric(s) (e.g. the streaming buffer level).

Thus, according to embodiments of the disclosure, a UE provides session status information pertaining to a QoE measurement session to a RAN node when the UE resumes its RRC connection after a period in RRC_INACTIVE state. (Or that a UE provides session status information pertaining to a QoE measurement session to a RAN node when the UE sets up an RRC connection after a period in RRC_IDLE state.)

In a first aspect of the disclosure, a method is performed by a user equipment. The method comprises, upon transitioning to a connected state, connecting to a first RAN node of a communication network. The method further comprises transmitting, to the communication network, information related to one or more QoE, measurement sessions configured at the user equipment. The one or more QoE measurement sessions were configured at the user equipment during a previous instance of the user equipment in the connected state.

In a second aspect of the disclosure, a method is performed by a user equipment. The method comprises, while in an inactive connectivity state, transmitting to a first RAN node of a communication network, information related to one or more QoE, measurement sessions configured at the user equipment.

In a third aspect of the disclosure, a method is performed by a first network node of a communication network. The method comprises. upon a user equipment connecting to the first network node and transitioning to a connected state, receiving, from one or more of the user equipment and a second network node of the communication network, information related to one or more QoE, measurement sessions configured at the user equipment. The one or more QoE measurement sessions were configured at the user equipment during a previous instance of the user equipment in the connected state.

In a fourth aspect of the disclosure, a method is performed by a second network node. The second network node serves a user equipment which is released to an inactive or idle connectivity state. The method comprises transmitting, to a first network node to which the user equipment has subsequently connected upon transitioning to a connected state, information related to one or more QoE measurement sessions configured at the user equipment.

Certain embodiments may provide the technical advantage(s) of enabling the network to become aware of the true session status (e.g., QoE measurement session) in the UE when the UE returns to the connected state (e.g., RRC_CONNECTED) after a period of time in an inactive or idle state (e.g., RRC_INACTIVE or RRC_IDLE).

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 5 is a signalling diagram illustrating a UE capability enquiry procedure;

FIG. 6 is a signalling diagram illustrating the transmission of UE capability information;

FIG. 7 is a signalling diagram illustrating a measurement control procedure;

FIG. 8 is a signalling diagram illustrating a measurement reporting procedure;

FIG. 9 is a signalling diagram illustrating a UE capability transfer procedure;

FIG. 10 is a signalling diagram illustrating an application layer measurement reporting procedure;

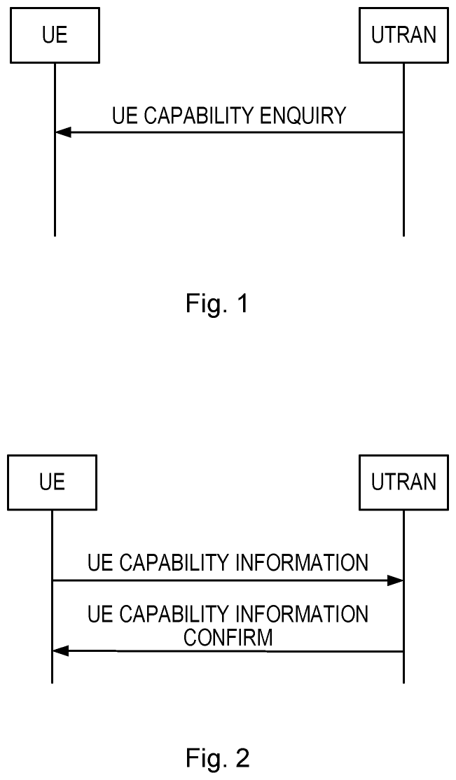

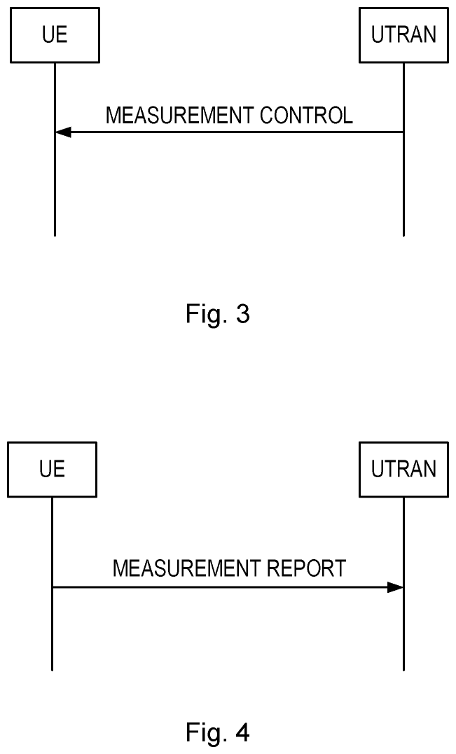

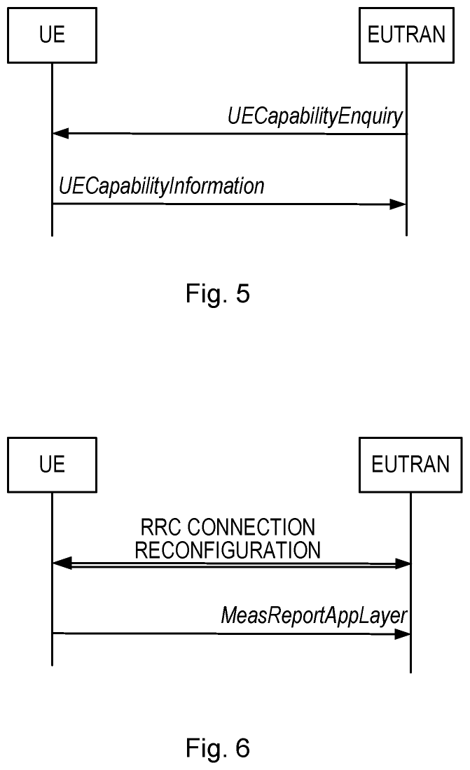

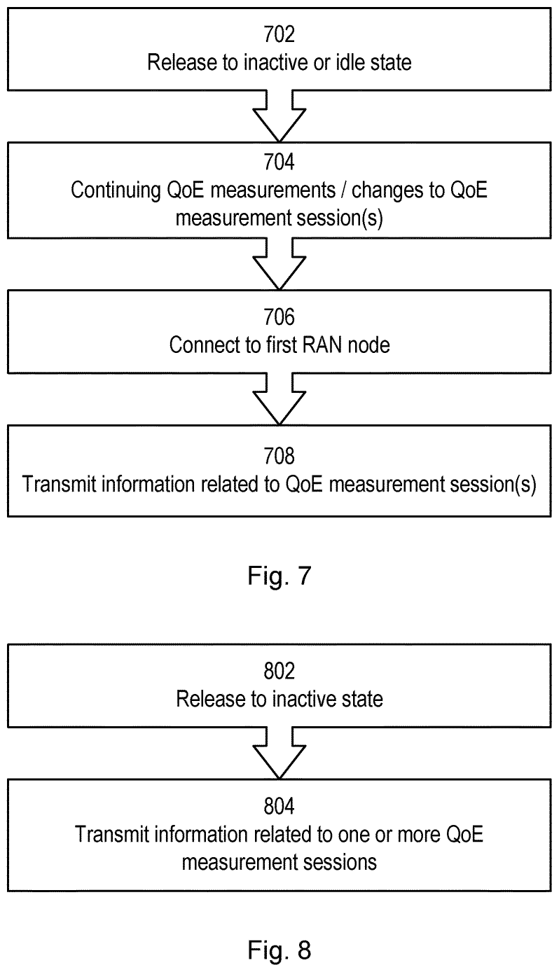

FIG. 7 is a schematic flowchart showing a method in accordance with some embodiments;

FIG. 8 is a schematic flowchart showing a method in accordance with some embodiments;

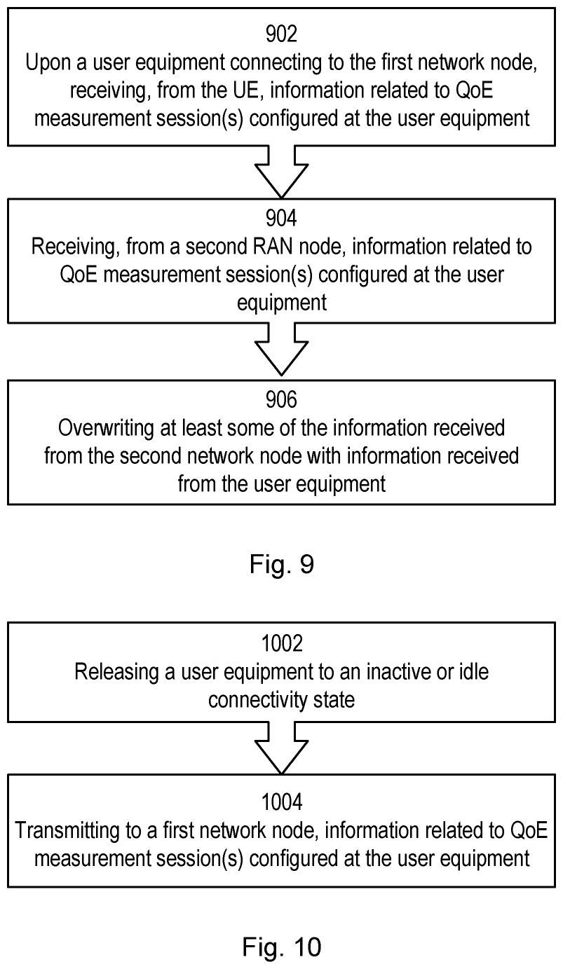

FIG. 9 is a schematic flowchart showing a method in accordance with some embodiments;

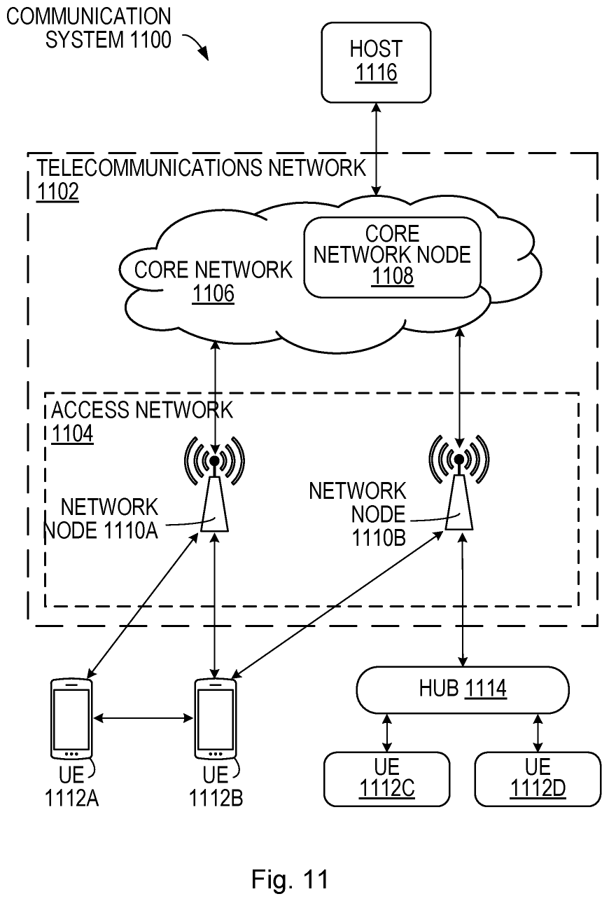

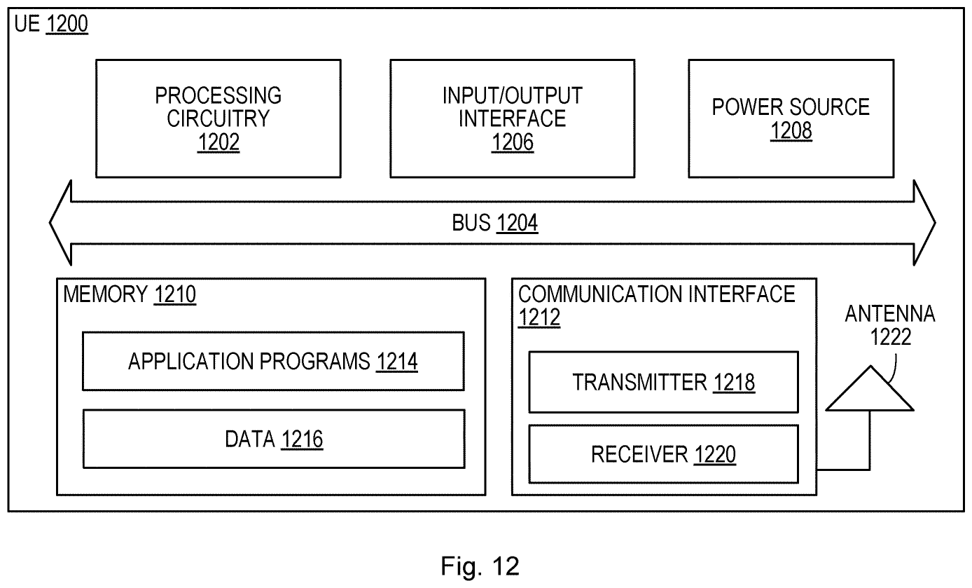

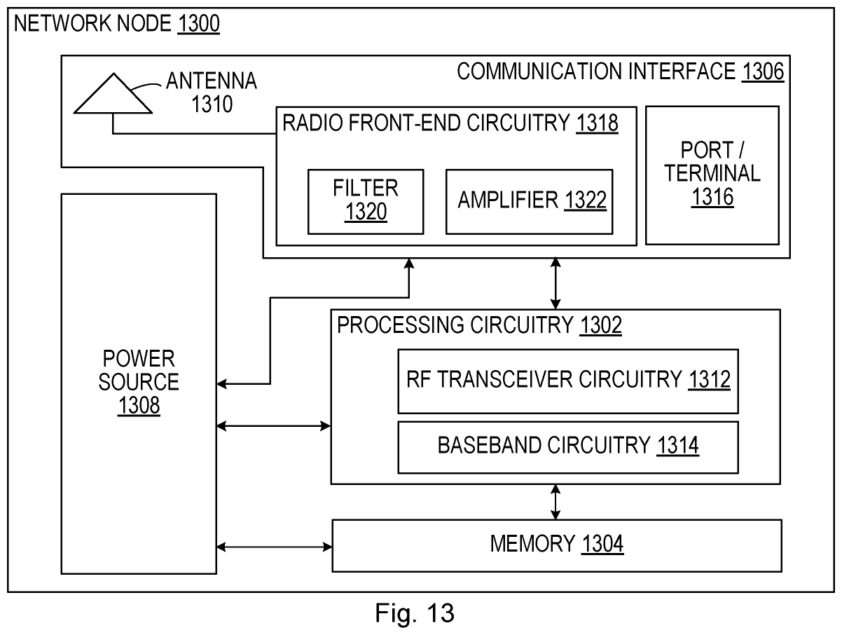

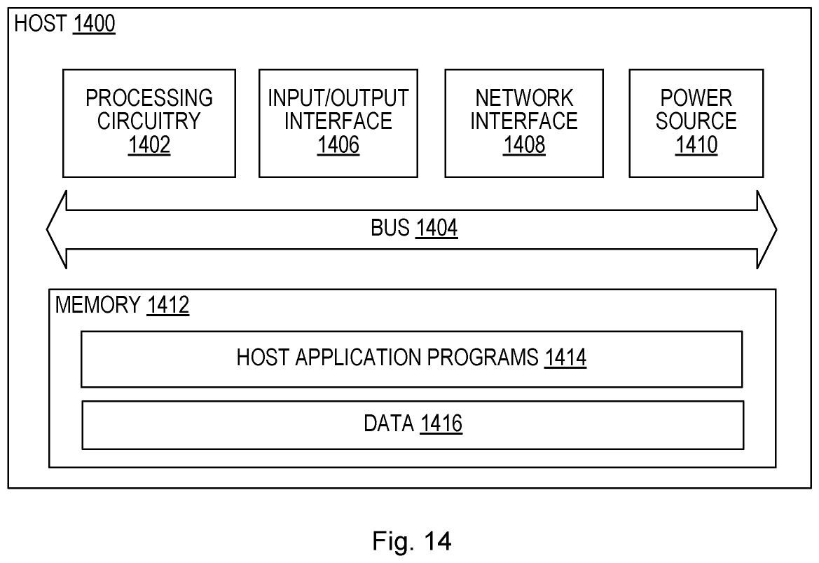

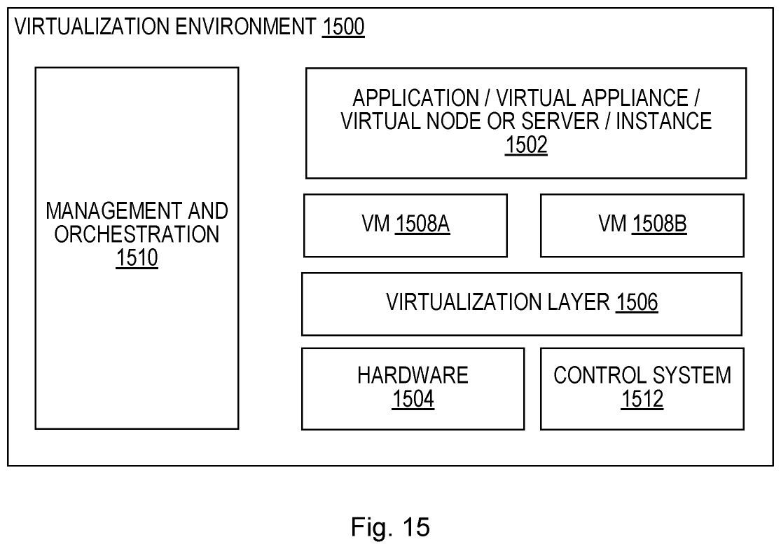

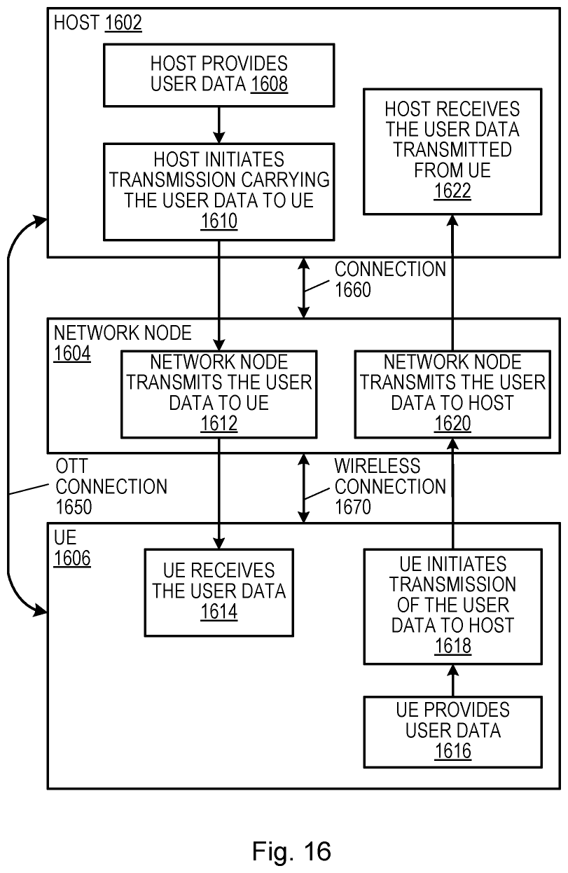

FIG. 10 is a schematic flowchart showing a method in accordance with some embodiments;

FIG. 11 shows an example of a communication system in accordance with some embodiments;

FIG. 12 shows a UE in accordance with some embodiments;

FIG. 13 shows a network node in accordance with some embodiments;

FIG. 14 is a block diagram of a host in accordance with various aspects described herein;

FIG. 15 is a block diagram illustrating a virtualization environment in which functions implemented by some embodiments may be virtualized; and

FIG. 16 is a block diagram showing a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

### Terminology and Generalizations

The terms “UE”, “terminal equipment” and “wireless terminal” are used interchangeably.

The terms “MCE” and “TCE” are used interchangeably.

The terms “QoE measurement” and “application layer measurement” are used interchangeably.

The terms “application layer measurement configuration”, “application measurement configuration”, “QoE measurement configuration”, “QoE configuration”, “QoE measurement and reporting configuration” and “QMC configuration” are used interchangeably. Note that the term “QMC configuration file” is not an equivalent term, but instead refers to the part of the QoE configuration consisting of an XML file containing instructions of QoE metrics to be collected etc.

The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

The terms “QoE measurement” and “application layer measurement” refer to the same kind of measurement.

The terms “modem”, “radio layer”, “RRC layer” and “radio network layer” are used interchangeably when referring to a UE.

The terms “access stratum” and “radio layer” are used interchangeably when referring to a UE.

The term “session” is used frequently herein, and it may refer to either a QoE measurement session or an application session or an application session for which QoE measurement is applied.

An application session and a QoE measurement session configured to measure on or collect data from the application session are strongly related. In this document, this is often reflected by referring to a QoE measurement session as being associated with an application session, or by referring to an application session as being associated with a QoE measurement session. When a session of an application of a certain service type is started, and QoE measurements are configured for that service type (i.e. there is a QoE measurement configuration targeting the service type), then a QoE measurement session is also started. The application session and an associated QoE measurement session should thus be started at the same time. Thus, an application session and an associated QoE measurement session are (under normal circumstances) started simultaneously or with a delay between the initiation of the application session and the start of the QoE measurement session that is small enough to be negligible. A possible exception may be if an application session of a certain service type is started and subsequently (while the application session is ongoing) a QoE configuration targeting the service type is received at the UE application layer, and the UE application layer then starts a QoE measurement session to measure on the running application session (instead of the alternative option to not start a QoE measurement session for an already ongoing application session, but instead wait for the next application session of the targeted service type). The same principles apply for RVQoE measurements. In the description below, unless otherwise stated, an application session and its associated QoE measurement session and/or RVQoE measurement session are assumed to be started simultaneously or with negligible delay between the application session and the QoE measurement session. Mechanisms specifically addressing the case where a QoE measurement session and/or an RVQoE measurement session is started while the associated application session is already ongoing (i.e. the QoE measurement session and/or RVQoE measurement session is started with a non-negligible delay) may also be covered by the embodiments described herein.

With the above description of the relation between an application session and an associated QoE measurement session, it is relevant to discuss the meaning of a “session start” indication (which is a term frequently used in the description). Whether a session start indication refers to an application session or a QoE measurement session has not been clear in 3GPP during the work with the specification of the QoE framework (in particular QoE for NR). However, the first release 17 version of the NR RRC specification (3GPP TS 38.331 version 17.0.0) implies that a session start indication sent from the UE to the gNB (in the form of an applicationLayerSessionStatus-r17 parameter set to “started” in the MeasurementReportAppLayer message) refers to a started QoE measurement session, and the same should then assumedly apply for the session start indication sent from the UE application layer to the UE AS. Hence, that a session start indication refers to a QoE measurement session is the basic assumption in the description herein; however, a session start indication may additionally or alternatively refer to an application session (with an associated QoE configuration).

The solution proposed in this disclosure applies to UMTS, LTE, NR and future radio access technologies, such as 6G.

All references to the application layer are with respect to the application layer of the UE (since RAN nodes do not have an application layer).

The solution proposed in this disclosure applies to both signaling- and management-based QoE measurements (but may also optionally be restricted to apply to only one of them).

To transition from RRC_INACTIVE state to RRC_CONNECTED state, a UE performs a procedure by which the UE's RRC connection is said to be resumed. This procedure may herein be referred to as a resume procedure, a connection resume procedure, an RRC connection resume procedure or an RRC resume procedure. This procedure consists of a three-way message exchange between the UE and the network (e.g. a gNB), including an RRCResumeRequest or RRCResumeRequest1 message from the UE, followed by an RRCResume message from the network, followed by an RRCResumeComplete message from the UE.

To transition from RRC_IDLE state to RRC_CONNECTED state, a UE performs a procedure which establishes an RRC connection for the UE. This procedure may herein be referred to as a connection establishment procedure, an RRC connection establishment procedure, a setup procedure, an RRC setup procedure or an RRC connection setup procedure. In NR, this procedure consists of a three-way message exchange between the UE and the network (i.e., a gNB), including an RRCSetupRequest message from the UE, followed by an RRCSetup message from the network, followed by an RRCSetupComplete message from the UE. In LTE, this procedure consists of a three-way message exchange between the UE and the network (i.e., an eNB), including an RRCConnectionRequest message from the UE, followed by an RRCConnectionSetup message from the network, followed by an RRCConnectionSetupComplete message from the UE.

The embodiments herein are primarily described in 5G/NR terms, implying application of the solution in 5G/NR; however, embodiments of the disclosure are also applicable in LTE (in which case for instance a gNB would be replaced by an eNB), UMTS and/or future systems (e.g., 6G). For the example of LTE, the messages RRCRelease, RRCResumeRequestRRCResumeRequest1, RRCResume, RRCResumeComplete, RRCSetupRequest, RRCSetup, RRCSetupComplete, RRCReconfiguration and MeasurementReportAppLayer in NR correspond to the messages RRCConnectionRelease, RRCConnectionResumeRequest, RRCConnectionResume, RRCConnectionResumeComplete, RRCConnectionRequest, RRCConnectionSetup, RRCConnectionSetupComplete, RRCConnectionReconfiguration and MeasReportAppLayer in LTE.

### Embodiments of the Disclosure

According to embodiments of the disclosure, to address the problems described above, information about the QoE measurement session(s) (e.g. ongoing, not ongoing, terminated, . . . ) during a past RRC_INACTIVE period is provided from the UE to the network when the RRC connection is resumed (i.e. the UE sends this information to the new RAN node in which the UE resumes its RRC connection). For further discussion of these embodiments, see FIGS. 7 and 9. The information could be sent e.g. in the RRCResumeRequest message, the RRCResumeComplete message, a MeasurementReportAppLayer message, the UEAssistanceInformation message or a UEInformationResponse message (on request from the new RAN node in a UEInformationRequest message, optionally after the UE has indicated availability of such information in the RRCResumeComplete message), or a newly introduced message. As an option, the UE sends the session status information to the RAN node towards which it performs the RRC resume procedure only if the session status is “ongoing”. As another option, the UE sends the session status information to the RAN node towards which it performs the RRC resume procedure only if the session status has changed, compared to the moment when the UE entered the INACTIVE state.

If retention of a QoE configuration in RRC_IDLE state is enabled in future 3GPP releases, the above solution may be applicable also in the case where the UE is released to RRC_IDLE state and later sets up a new RRC connection, possibly towards a new RAN node. In this case, the RRC resume procedure is replaced by an RRC setup procedure and among the above described messages the UE could send the session status information in, the RRCResumeRequest message is replaced by an RRCSetupRequest message and the RRCResumeComplete message is replaced by an RRCSetupComplete message, or in a newly defined message.

### Variations, Extensions and Complements of the Core Principle with Regards to Session Status Information Signaling

When a UE in RRC_INACTIVE state initiates an RRC resume procedure towards a new RAN node (e.g., gNB or eNB), the anchor RAN node (e.g., gNB or eNB) could transfer the session ongoing/not ongoing status that was valid when the UE was released to RRC_INACTIVE state, but that information may be outdated and incorrect. So, this information could optionally be excluded from the UE context information that is transferred (e.g., in the RETRIEVE UE CONTEXT RESPONSE XnAP message) from the anchor RAN node to the new RAN node where the UE resumes the RRC connection, or, as another option, it may be included in the UE context transferred from the anchor RAN node to the new RAN node, but will then be overridden by the information sent from the UE. As a further option, the session status (i.e., the ongoing/not ongoing status) that was valid when the UE was released to RRC_INACTIVE state is included in the UE context information that is transferred (e.g. in the RETRIEVE UE CONTEXT RESPONSE XnAP message) from the anchor RAN node to the new RAN node where the UE resumes the RRC connection, and the UE sends overriding session status information to the new RAN node only if it is different from the session status information sent from the anchor RAN node to the new RAN node (i.e. if the session status information in the UE is different from what it was when the UE was released to RRC_INACTIVE state).

Note that although the solution embodiments described herein refer to a case where the UE performs the RRC resume procedure (or RRC setup procedure) towards another RAN node than the RAN node that released the UE to RRC_INACTIVE state (or RRC_IDLE state), the solution embodiments are applicable also when the UE performs the RRC resume procedure (or RRC setup procedure) towards the same RAN node as released the UE to RRC_INACTIVE state (or RRC_IDLE state), wherein even the cell in which the UE performs the RRC resume procedure (or RRC setup procedure) may be the same as the cell in which the UE was released to RRC_INACTIVE state (or RRC_IDLE state).

In case the UE is in dual connectivity, and in case the SN has configured the UE for QoE measurements, the SN is the node that has the knowledge about the session status. In that case, the SN informs the MN about the session status, and the MN may inform the new RAN node upon RRC resume of RRC connection establishment. To do this, the SN may use one of the existing DC-related XnAP procedures (with possible enhancements) or a newly defined procedure.

It should be pointed out that the session status pertaining to a QoE configuration may change more than once while the UE is in RRC_INACTIVE state. For instance, if the QoE measurement session (and its associated application session) that was ongoing when the UE was released to RRC_INACTIVE state ended while the UE was in RRC_INACTIVE state, and another application session of the same type, with an associated QoE measurement session (configured by the same QoE configuration), subsequently started while the UE was still in RRC_INACTIVE state, the UE may indicate that this has occurred, e.g. by providing a list of session status indications (e.g., in this case, a session stop indication followed by a session start indication) to the RAN node towards which the UE resumes the RRC connection. Optionally, a timestamp may be associated with each provided session status indication.

In an alternative solution, the UE sends a session ongoing/not ongoing status indication at the resume procedure only if the status has changed compared to the latest status indication that the UE sent before transferring to RRC_INACTIVE. That means that the network does not receive information about session status updates while the UE is in RRC_INACTIVE, but it receives the latest information when the UE is resumed to RRC_CONNECTED. The network may in this solution forward the session status information from the source to the target node, for the case when the status is the same after the resume and the UE does not send any information to the network. This solution may be combined with the solution of the UE signaling further information to the network.

Signaling of Additional Information than the Session Status

Further information that the UE could provide to the RAN node towards which it performs the RRC resume procedure may include an indication of how long time the UE spent in RRC_INACTIVE state, e.g., indicated as a duration or as a timestamp of the time the UE was released to RRC_INACTIVE state.

The UE may transmit information about when sessions were ongoing or not while in RRC_INACTIVE. As an example, from time a to time b, the UE had a session ongoing, from time be to time c, there was no session ongoing, from time c to time d, there was a session ongoing etc. As a simplified option, the UE may indicate the timestamp corresponding to the moment the session started and/or ended while in RRC_INACTIVE state.

The anchor RAN node may also provide the new RAN node with more information than the latest known session status of the UE (i.e. the session status that was valid when the UE was released to RRC_INACTIVE state). Such additional information may include e.g. for how long time the UE has been in RRC_INACTIVE state e.g. indicated as a duration or as a timestamp of the time the ULE was released to RRC_INACTIVE state. Yet further information that the anchor RAN node may provide to the new RAN node may include one or more latest RVQoE metric value, such as the last streaming buffer level the UE reported before the UE was released to RRC_INACTIVE state, and optionally a timestamp associated with that buffer level. Since the latest known session status of the UE may be omitted in accordance with an option described above, it is possible that the anchor RAN node omits the latest known session status of the UE, but still provides any of the above described additional/further information, e.g. the information about the duration of the UE's RRC_INACTIVE period (possibly in the form of an indication of the time of release to RRC_INACTIVE state), and/or one or more of the RVQoE metric value(s) latest reported by the UE.

### State Transition Triggers

The trigger for a UE with an active application session to initiate the RRC resume procedure may typically be that the application generates uplink data to be transmitted (e.g. a request to an application server, e.g. a request for streaming data). In another option, the trigger for the RRC resume procedure may be that a buffer for an application session has emptied or has fallen below a certain threshold, or it exhibits a decreasing trend. In another option, the trigger may be a paging message from the network. The paging message may be triggered by downlink application data pending to be transmitted to the UE. In the case of a UE in RRC_INACTIVE state, the UE may be paged through RAN paging and reception of the page will trigger the UE to initiate the RRC resume procedure to transit to RRC_CONNECTED state. In the case of a UE in RRC_IDLE state (which may be relevant in the context of this disclosure, particularly if future 3GPP releases enable a UE to retain a QoE configuration in RRC_IDLE state), the UE may be paged through CN paging and reception of the page will trigger the UE to initiate the RRC setup procedure to transit to RRC_CONNECTED state. The decision to provide session status information from the UE to the new RAN node, and/or what information to provide, may depend on the nature of the trigger of the RRC resume (or RRC setup) procedure, which will be further explained below in conjunction with the description of configuration.

In one option, the UE may also provide to the network the QoE-specific reason for initiating RRC resume, e.g., as described above (UL data to send, buffer depletion etc.).

### Configuration of the UE's Behavior

Whether a UE should provide session status information when resuming a connection in a RAN node (or performing an RRC setup procedure after a period in RRC_IDLE state), as well as what type of information to provide, may be configured by the network.

As one option, the RAN node releasing the UE to RRC_INACTIVE state (or RRC_IDLE state) may indicate in the message releasing the UE to RRC_INACTIVE state (or RRC_IDLE state), e.g. an RRCRelease message, instructions of possible session status information reporting to be provided from the UE to the RAN node towards which the UE performs a subsequent RRC resume procedure. Such instructions may for instance indicated whether the UE should provide its session status information, whether this should be done only if the session status has changed or is different from what it was at the time when the UE is released to RRC_INACTIVE state (or RRC_IDLE state) (e.g. the session status when the UE receives the RRCRelease message), and/or what type of information the UE should provide (e.g. only the latest/current session status or a list of session status indications, and/or additional information such as the duration of the period in RRC_INACTIVE state (or RRC_IDLE state).

As another option, the RAN node towards which the UE performs the RRC resume procedure (or RRC setup procedure) may include instructions like the ones described above in the RRCResume message (or RRCSetup message).

In another option, the RAN node configures the UE to transmit session status updates in the UEAssistanceInformation message.

As yet another option, the RAN node towards which the UE performs the RRC resume procedure (or RRC setup procedure) may use a UEInformationRequest message to explicitly request the UE to send certain session status information and/or additional information in a UEInformationResponse message (possibly after the UE has indicated the availability of such information in the RRCResumeComplete message (or the RRCSetupComplete message).

As yet another option, the RAN node towards which the UE performs the RRC resume procedure (or RRC setup procedure) may use an RRCReconfigurationRequest message to explicitly request the UE to send certain session status information and/or additional information, e.g. in a MeasurementReportAppLayer message.

As yet another option, which may complement (e.g. be used in parallel with) any of the options above, if the RRC resume procedure is triggered by a page, the RAN node may include the above described type of instructions in the RRC Paging message.

As yet another option, the instructions may be indicated in broadcast system information. If this option is used, in one variant it may be used as the default instructions, which may be overridden, or complemented by instructions provided to the UE in any of the above-described ways.

The UE may be configured to transmit all updates of the session status, or it may be configured to transmit session status updates only at resume to RRC_CONNECTED only if the session status has change since the UE was transferred to RRC_INACTIVE (or RRC_IDLE).

The instructions may be unconditional, but in some variants, they may depend on one or more conditions. For example, the instructions, or parts of the instructions, may be conditioned by the type of trigger of the RRC resume procedure (or RRC setup procedure), e.g. such that the instructions depend on whether the trigger is UE internal trigger or a page.

In another option, the RAN node may configure the UE to initiate RRC resume when the session status has changed, e.g., when session starts or ends, and to provide the session information in conjunction to it.

A further condition may target the case of a UE internal trigger, e.g. such that the instructions may depend on whether the UE internal trigger is generation of application data (of an application with an associated QoE configuration for which the instructions apply) or another UE internal trigger.

A further condition may target the case of the trigger being a page, e.g. such that the instructions may depend on whether the page is a RAN initiated page or a CN initiated page.

In another example, the instructions, or parts of the instructions, may be conditioned by whether the RAN node the UE performs the RRC resume procedure (or RRC setup procedure) towards is the same as the old RAN node (i.e. the RAN node that released the UE to RRC_INACTIVE state (or RRC_IDLE state)) or another RAN node. In this example, a possible further condition could target the case where the RAN node the UE performs the RRC resume procedure (or RRC setup procedure) towards is the same as the old RAN node, e.g. such that the instructions may depend on whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by the type of state transition procedure (i.e. which state the UE is leaving to enter RRC_CONNECTED state), e.g. such that the instructions may depend on whether the state transition procedure is an RRC resume procedure (to let the UE transit from RRC_INACTIVE state to RRC_CONNECTED state) or an RRC setup procedure (to let the UE transit from RRC_IDLE state to RRC_CONNECTED state).

### Adaptation of the Solution to RRC_IDLE State and RRC Setup

In 3GPP release 17, retention of a QoE configuration in RRC_IDLE state is not supported, but this may be changed in future releases of the 3GPP standard. In anticipation of this potential augmentation of the 3GPP standard, all the methods, embodiments, options and variants described above involving RRC_INACTIVE state may be adapted to be applied in relation to the RRC_IDLE state instead of the RRC_INACTIVE state. This adaptation involves replacing the RRC resume procedure with the RRC setup procedure and removing the XnAP based (or X2AP based) context fetch, while keeping all the other essential principles and features of the methods, embodiments, options and variants. (Note that this adaptation to the RRC_IDLE state is to some extent explicitly described for some of the methods, embodiments, options and variants described above.)

In another embodiment, a RAN node, which releases a UE with QoE measurements configured, requests a core network entity (e.g. an AMF or an MME) to store a container with QoE related state information associated with the UE. This container may then be transferred to the RAN node which the UE subsequently performs an RRC setup procedure towards (i.e. the RAN node controlling the cell where the UE subsequently transits to RRC_CONNECTED state).

The information previously described herein as being transferred from an anchor RAN node to a new RAN node using the RETRIEVE UE CONTEXT RESPONSE XnAP message (e.g. the latest known session status in the UE) may in the case of RRC_IDLE state (and the RRC setup procedure) be transferred from the old to the new RAN node using this mechanism, i.e. by including it in the container stored in the core network to be transferred to a subsequent RAN node.

### Extensions

During a period in RRC_INACTIVE or RRC_IDLE state, a UE may also collect QoE metric values and/or other information for later reporting in QoE report(s) and/or RVQoE report(s). In addition to the regular QoE/RVQoE metrics, the UE can record the time when it was released RRC_CONNECTED state to RRC_INATIVE or RRC_IDLE state as well as the time when it reentered RRC_CONNECTED state (or alternatively the duration spent in RRC_INACTIVE or RRC_IDLE state. This information may be “integrated” with the QoE metric values in the report in a way that makes it clear which values are collected during which state. Other ways to indicate which state(s) different values have been collected in are also conceivable. For instance, the report may indicate in which states certain parts of the report content was collected, or indicate the state associated with collected measurement values or samples.

Other state related information that may be included in the report may include the type of trigger of the state transition from RRC_INACTIVE or RRC_IDLE state to RRC_CONNECTED state, e.g. a UE internal trigger or a ULE external trigger (e.g. a page), and/or if in the case of a UE internal trigger, whether the UE internal trigger is generation of application data or buffer emptying (in the application session the QoE report and/or RVQoE report pertains to) or another UE internal trigger, and/or in the case of a UE external trigger in the form of a page, whether the page was a RAN page or a core network page.

UE Providing RAN with Updated Session Status Information while in RRC_INACTIVE State

See, for example, FIG. 8 for more information. A solution to allow an anchor RAN node to keep up to date information concerning the session status information for UEs in RRC_INACTIVE and eventually transfer the correct (up to date) session status information to a new RAN node when the UE resumes from RRC_INACTIVE state, is that the UE, while remaining in RRC_INACTIVE (i.e. without transitioning to RRC_CONNECTED state) can send updated session status information by means of Small Data Transmission procedure.

The RAN can configure triggers for the UE for sending (updated) session status information. Triggers could be one or any combination of:
UE is in RRC_INACTIVE state and a session that was ongoing when UE was released to RRC_INACTIVE ended successfully
UE is in RRC_INACTIVE state and a session that was ongoing when UE was released to RRC_INACTIVE ended unsuccessfully
UE is in RRC_INACTIVE state and a new application session started
UE is in RRC_INACTIVE state and one or more changes occurred in the status of an application session that was ongoing when UE was released to RRC_INACTIVE
UE is in RRC_INACTIVE state and one or more changes occurred in the status of a new application session that started after the UE was released to RRC_INACTIVE
UE has reselected a new cell of the anchor RAN node (or a new cell of another RAN node)
A timer has expired (e.g. T380) or is running
The data volume is below a threshold
The data volume for SRB4 is below a threshold

Existing SDT procedures can be reused and extended for sending session status information. For example, if session status information is treated as SRB data, and the UE accesses a gNB other than the last serving gNB (anchor RAN node), SRB PDCP PDUs can be transferred between the receiving gNB and the last serving gNB via the XnAP RRC Transfer procedure, until the last serving gNB terminates the SDT session and moves the UE back to RRC_INACTIVE by sending the RRCRelease message.

In a possible example of realization, the possibility to use SDT for sending updated session status information can be signaled from RAN to UE when the UE is released to RRC_INACTIVE by means of a specific flag indicating the possibility to use SDT for SRB4, e.g. introducing a new IE: sdt-SRB4-Indication ENUMERATED {allowed} OPTIONAL

At minimum, the anchor node is provided with updated session status information, while the RAN node contacted for SDT procedure (if different from the anchor node) does not store such information (there is no guarantee about which RAN node the UE will eventually resume, and the session status information is originally stored in the anchor RAN node. However, if—as part of the SDT procedure—the UE context is relocated, this information becomes relevant for the RAN node contacted for SDT procedure and such node can store the updated session status information when received from the UE.

In a possible solution, UE can provide an update to RAN concerning the session status information as part of RRCResume procedure triggered due to RNA update (e.g. for UE moving out of RNA, or due to expiry of T380 timer for periodic RNA update).

FIG. 7 depicts a method in accordance with particular embodiments. The method may be performed by a UE or wireless device (e.g. the UE 1112 or UE 1200 as described later with reference to FIGS. 11 and 12 respectively).

The method begins with the UE initially in the connected state (e.g., an RRC state such as RRC_CONNECTED). The UE may be configured with one or more QoE measurement sessions associated with respective application sessions. In step 702, the UE is released to an inactive or idle state (e.g., RRC_INACTIVE or RRC_IDLE).

While in the inactive or idle state, in step 704, the UE may continue to perform QoE measurements on application sessions which survive the transition to the inactive or idle state. For example, a streaming application may have a buffer of video data that lasts several minutes. This means that a streaming session may well survive a significant period without communication, which may occur, e.g., when if the UE is temporarily released to RRC_INACTIVE state (or even RRC_IDLE state). Additionally or alternatively, while in the inactive or idle state, changes to the one or more QoE measurement sessions may occur. For example, a new QoE measurement session (and associated application session) may start, or a previously ongoing QoE measurement session (and associated application session) may end or terminate.

In step 706, the UE transitions back to the connected state. For example, the UE may resume a connection that was previously suspended (i.e., moving from RRC_INACTIVE to RRC_CONNECTED) or establish a new connection (i.e., moving from RRC_IDLE to RRC_CONNECTED). As part of this transition, the UE connects to a first RAN node. Note that the first RAN node may be the same RAN node that the UE was previously connected to (e.g., in step 702) or a different RAN node.

In step 708, the UE transmits, to the first RAN node, information related to one or more QoE measurement sessions configured at the user equipment.

The information may be transmitted to the first RAN node in a connection resume request message (e.g., RRCResumeRequest, RRCResumeRequest1, etc) or a connection establishment request message (e.g., RRCSetupRequest, RRCConnectionSetup etc). Alternatively, the information may be transmitted to the first RAN node in a message confirming establishment of a connection to the first RAN node or resumption of a connection with the first RAN node (e.g., RRCResumeComplete, RRCSetupComplete, etc), in a response message to a request message from the first RAN node (e.g., UEInformationResponse message in response to a UEInformationRequest message from the first RAN node) or in any other suitable message (e.g., MeasurementReportAppLayer, UEAssistanceInformation, etc).

The information related to one or more QoE measurement sessions configured at the user equipment may comprise a status of the one or more QoE measurement sessions (e.g., ongoing, not ongoing, terminated, etc). In one embodiment, the information may comprise the status of only those QoE measurement sessions that are ongoing. In such embodiments, the information may comprise a list of identities for the QoE measurement sessions, and the status itself (i.e., “ongoing”) may be implicit.

In further embodiments, the information related to one or more QoE measurement sessions may comprise values for one or more parameters (e.g., session status) that have changed since the user equipment transitioned from the connected state to an inactive state or an idle state in step 702. In this way, the RAN node to which the UE was connected in step 702 may forward information as to the QoE measurement sessions at the time that the UE was released to the inactive or idle state. The information from the UE may comprise only those parameters which have changed, saving radio resources and signalling overhead.

The information related to one or more QoE measurement sessions may additionally or alternatively comprise one or more of: an indication of an amount of time that the user equipment was in an inactive or idle state before transitioning to the connected state; and an indication of when or how long one or more QoE measurement sessions were ongoing or not while the user equipment was in an inactive or idle state.

Thus, further information that the UE could provide to the RAN node towards which it performs the RRC resume procedure may include an indication of how long time the UE spent in RRC_INACTIVE state, e.g., indicated as a duration or as a timestamp of the time the UE was released to RRC_INACTIVE state.

The UE may transmit information about when sessions were ongoing or not while in RRC_INACTIVE. As an example, from time a to time b, the UE had a session ongoing, from time be to time c, there was no session ongoing, from time c to time d, there was a session ongoing etc. As a simplified option, the UE may indicate the timestamp corresponding to the moment the session started and/or ended while in RRC_INACTIVE state.

The information related to one or more QoE measurement sessions may be transmitted to the first RAN node responsive further to one or more of: a configuration received from the communication network; and a type of event that triggered the user equipment to transition to the connected state.

For example, the trigger for a UE with an active application session to initiate the RRC resume procedure may typically be that the application generates uplink data to be transmitted (e.g. a request to an application server, e.g. a request for streaming data). In another option, the trigger for the RRC resume procedure may be that a buffer for an application session has emptied or has fallen below a certain threshold, or it exhibits a decreasing trend. In another option, the trigger may be a paging message from the network. The paging message may be triggered by downlink application data pending to be transmitted to the UE. In the case of a UE in RRC_INACTIVE state, the UE may be paged through RAN paging and reception of the page will trigger the UE to initiate the RRC resume procedure to transit to RRC_CONNECTED state. In the case of a UE in RRC_IDLE state (which may be relevant in the context of this disclosure, particularly if future 3GPP releases enable a UE to retain a QoE configuration in RRC_IDLE state), the UE may be paged through CN paging and reception of the page will trigger the UE to initiate the RRC setup procedure to transit to RRC_CONNECTED state. The decision to provide session status information from the UE to the new RAN node, and/or what information to provide, may depend on the nature of the trigger of the RRC resume (or RRC setup) procedure, which will be further explained below in conjunction with the description of configuration.

In one option, the UE may also provide to the network the QoE-specific reason for initiating RRC resume, e.g., as described above (UL data to send, buffer depletion etc.).

Whether a UE should provide session status information when resuming a connection in a RAN node (or performing an RRC setup procedure after a period in RRC_IDLE state), as well as what type of information to provide, may be configured by the network.

As one option, the RAN node releasing the ULE to RRC_INACTIVE state (or RRC_IDLE state) may indicate in the message releasing the UE to RRC_INACTIVE state (or RRC_IDLE state), e.g. an RRCRelease message, instructions of possible session status information reporting to be provided from the UE to the RAN node towards which the UE performs a subsequent RRC resume procedure. Such instructions may for instance indicated whether the UE should provide its session status information, whether this should be done only if the session status has changed or is different from what it was at the time when the UE is released to RRC_INACTIVE state (or RRC_IDLE state) (e.g. the session status when the UE receives the RRCRelease message), and/or what type of information the UE should provide (e.g. only the latest/current session status or a list of session status indications, and/or additional information such as the duration of the period in RRC_INACTIVE state (or RRC_IDLE state).

As another option, the RAN node towards which the UE performs the RRC resume procedure (or RRC setup procedure) may include instructions like the ones described above in the RRCResume message (or RRCSetup message).

In another option, the RAN node configures the UE to transmit session status updates in the UEAssistanceInformation message.

As yet another option, the RAN node towards which the UE performs the RRC resume procedure (or RRC setup procedure) may use a UEInformationRequest message to explicitly request the UE to send certain session status information and/or additional information in a UEInformationResponse message (possibly after the UE has indicated the availability of such information in the RRCResumeComplete message (or the RRCSetupComplete message).

As yet another option, the RAN node towards which the UE performs the RRC resume procedure (or RRC setup procedure) may use an RRCReconfigurationRequest message to explicitly request the UE to send certain session status information and/or additional information, e.g. in a MeasurementReportAppLayer message.

As yet another option, which may complement (e.g. be used in parallel with) any of the options above, if the RRC resume procedure is triggered by a page, the RAN node may include the above described type of instructions in the RRC Paging message.

As yet another option, the instructions may be indicated in broadcast system information. If this option is used, in one variant it may be used as the default instructions, which may be overridden, or complemented by instructions provided to the UE in any of the above-described ways.

The UE may be configured to transmit all updates of the session status, or it may be configured to transmit session status updates only at resume to RRC_CONNECTED only if the session status has change since the UE was transferred to RRC_INACTIVE (or RRC_IDLE).

The instructions may be unconditional, but in some variants, they may depend on one or more conditions. For example, the instructions, or parts of the instructions, may be conditioned by the type of trigger of the RRC resume procedure (or RRC setup procedure), e.g. such that the instructions depend on whether the trigger is UE internal trigger or a page.

In another option, the RAN node may configure the UE to initiate RRC resume when the session status has changed, e.g., when session starts or ends, and to provide the session information in conjunction to it.

A further condition may target the case of a UE internal trigger, e.g. such that the instructions may depend on whether the UE internal trigger is generation of application data (of an application with an associated QoE configuration for which the instructions apply) or another UE internal trigger.

A further condition may target the case of the trigger being a page, e.g. such that the instructions may depend on whether the page is a RAN initiated page or a CN initiated page.

In another example, the instructions, or parts of the instructions, may be conditioned by whether the RAN node the UE performs the RRC resume procedure (or RRC setup procedure) towards is the same as the old RAN node (i.e. the RAN node that released the UE to RRC_INACTIVE state (or RRC_IDLE state)) or another RAN node. In this example, a possible further condition could target the case where the RAN node the UE performs the RRC resume procedure (or RRC setup procedure) towards is the same as the old RAN node, e.g. such that the instructions may depend on whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by the type of state transition procedure (i.e. which state the UE is leaving to enter RRC_CONNECTED state), e.g. such that the instructions may depend on whether the state transition procedure is an RRC resume procedure (to let the UE transit from RRC_INACTIVE state to RRC_CONNECTED state) or an RRC setup procedure (to let the UE transit from RRC_IDLE state to RRC_CONNECTED state).

FIG. 8 depicts a method in accordance with particular embodiments. The method may be performed by a ULE or wireless device (e.g. the UE 1112 or UE 1200 as described later with reference to FIGS. 11 and 12 respectively).

The method begins with the UE initially in the connected state (e.g., an RRC state such as RRC_CONNECTED), with a connection to a first RAN node. The UE may be configured with one or more QoE measurement sessions associated with respective application sessions. In step 802, the UE is released to an inactive state (e.g., RRC_INACTIVE).

While in the inactive state, in step 804, the UE transmits to the first RAN node information related to one or more QoE measurement sessions configured at the user equipment. The information may be transmitted to the first RAN node by means of one or more small data transmissions (SDT).

The information related to one or more QoE measurement sessions configured at the user equipment may comprise a status of the one or more QoE measurement sessions (e.g., ongoing, not ongoing, terminated, etc). In one embodiment, the information may comprise the status of only those QoE measurement sessions that are ongoing. In such embodiments, the information may comprise a list of identities for the QoE measurement sessions, and the status itself (i.e., “ongoing”) may be implicit.

In further embodiments, the information related to one or more QoE measurement sessions may comprise values for one or more parameters (e.g., session status) that have changed since the user equipment transitioned from the connected state to an inactive state or an idle state in step 702. In this way, the RAN node to which the UE was connected in step 702 may forward information as to the QoE measurement sessions at the time that the UE was released to the inactive or idle state. The information from the UE may comprise only those parameters which have changed, saving radio resources and signalling overhead.

The information related to one or more QoE measurement sessions may additionally or alternatively comprise one or more of: an indication of an amount of time that the user equipment was in an inactive or idle state before transitioning to the connected state; and an indication of when or how long one or more QoE measurement sessions were ongoing or not while the user equipment was in an inactive or idle state.

Thus, further information that the UE could provide to the RAN node towards which it performs the RRC resume procedure may include an indication of how long time the UE spent in RRC_INACTIVE state, e.g., indicated as a duration or as a timestamp of the time the UE was released to RRC_INACTIVE state.

The UE may transmit information about when sessions were ongoing or not while in RRC_INACTIVE. As an example, from time a to time b, the UE had a session ongoing, from time be to time c, there was no session ongoing, from time c to time d, there was a session ongoing etc. As a simplified option, the UE may indicate the timestamp corresponding to the moment the session started and/or ended while in RRC_INACTIVE state.

The information related to one or more QoE measurement sessions may be transmitted in step 804 responsive to one or more of: a QoE measurement session that was ongoing when the user equipment was released to the inactive connectivity state ending successfully; a QoE measurement session that was ongoing when the user equipment was released to the inactive connectivity state ending unsuccessfully; a new application session starting; one or more changes in a status of an application session that was ongoing when the user equipment was released to the inactive connectivity state; one or more changes in a status of an application session that started after the user equipment was released to the inactive connectivity state; a timer has expired or is running; the user equipment has reselected a new cell; data volume is below a threshold.

For example, the first RAN node may configure triggers for the UE for sending (updated) session status information. Triggers could be one or any combination of:
UE is in RRC_INACTIVE state and a session that was ongoing when UE was released to RRC_INACTIVE ended successfully
UE is in RRC_INACTIVE state and a session that was ongoing when UE was released to RRC_INACTIVE ended unsuccessfully
UE is in RRC_INACTIVE state and a new application session started
UE is in RRC_INACTIVE state and one or more changes occurred in the status of an application session that was ongoing when UE was released to RRC_INACTIVE
UE is in RRC_INACTIVE state and one or more changes occurred in the status of a new application session that started after the UE was released to RRC_INACTIVE
UE has reselected a new cell of the anchor RAN node (or a new cell of another RAN node)
A timer has expired (e.g. T380) or is running
The data volume is below a threshold
The data volume for SRB4 is below a threshold

Existing SDT procedures may be reused and extended for sending session status information. For example, if session status information is treated as SRB data, and the UE accesses a gNB other than the last serving gNB (anchor RAN node), SRB PDCP PDUs can be transferred between the receiving gNB and the last serving gNB via the XnAP RRC Transfer procedure, until the last serving gNB terminates the SDT session and moves the UE back to RRC_INACTIVE by sending the RRCRelease message.

The possibility to use SDT for sending updated session status information may be signaled from the first RAN node to the UE when the UE is released to RRC_INACTIVE (e.g., in step 802) by means of a specific flag indicating the possibility to use SDT for SRB4, e.g. introducing a new IE: sdt-SRB4-Indication ENUMERATED {allowed} OPTIONAL

The anchor (first) RAN node is therefore provided with updated session status information, while the RAN node contacted for SDT procedure (if different from the anchor node) does not store such information (there is no guarantee about which RAN node the UE will eventually resume, and the session status information is originally stored in the anchor RAN node. However, if—as part of the SDT procedure—the UE context is relocated, this information becomes relevant for the RAN node contacted for SDT procedure and such node can store the updated session status information when received from the UE.

In a possible solution, UE can provide an update to RAN concerning the session status information as part of RRCResume procedure triggered due to RNA update (e.g. for UE moving out of RNA, or due to expiry of T380 timer for periodic RNA update)

FIG. 9 depicts a method in accordance with particular embodiments. The method may be performed by a first network node (e.g. the network node 1110 or network node 1300 as described later with reference to FIGS. 11 and 13 respectively). The method of FIG. 9 may be read in conjunction with the methods of FIGS. 7 and 10, which set out corresponding steps in a UE and a second RAN node, respectively.

The method begins at step 902 in which, upon a user equipment connecting to the first network node and transitioning to a connected state, the first RAN node receives, from the UE, information related to one or more QoE measurement sessions configured at the user equipment. For example, the UE may resume a connection that was previously suspended (i.e., moving from RRC_INACTIVE to RRC_CONNECTED) or establish a new connection (i.e., moving from RRC_IDLE to RRC_CONNECTED). As part of this transition, the UE connects to the first RAN node.

The information may be transmitted to the first RAN node in a connection resume request message (e.g., RRCResumeRequest, RRCResumeRequest1, etc) or a connection establishment request message (e.g., RRCSetupRequest, RRCConnectionSetup etc). Alternatively, the information may be transmitted to the first RAN node in a message confirming establishment of a connection to the first RAN node or resumption of a connection with the first RAN node (e.g., RRCResumeComplete, RRCSetupComplete, etc), in a response message to a request message from the first RAN node (e.g., UEInformationResponse message in response to a UEInformationRequest message from the first RAN node) or in any other suitable message (e.g., MeasurementReportAppLayer, UEAssistanceInformation, etc).

The information related to one or more QoE measurement sessions configured at the user equipment may comprise a status of the one or more QoE measurement sessions (e.g., ongoing, not ongoing, terminated, etc). In one embodiment, the information may comprise the status of only those QoE measurement sessions that are ongoing. In such embodiments, the information may comprise a list of identities for the QoE measurement sessions, and the status itself (i.e., “ongoing”) may be implicit.

In further embodiments, the information related to one or more QoE measurement sessions may comprise values for one or more parameters (e.g., session status) that have changed since the user equipment transitioned from the connected state to an inactive state or an idle state. In this way, the RAN node to which the UE was previously connected (e.g., before being released to the inactive or idle state) may forward information as to the QoE measurement sessions at the time that the UE was released to the inactive or idle state (see step 904 below). The information from the UE may comprise only those parameters which have changed, saving radio resources and signalling overhead.

The information related to one or more QoE measurement sessions may additionally or alternatively comprise one or more of: an indication of an amount of time that the user equipment was in an inactive or idle state before transitioning to the connected state; and an indication of when or how long one or more QoE measurement sessions were ongoing or not while the user equipment was in an inactive or idle state.

Thus, further information that the UE could provide to the RAN node towards which it performs the RRC resume procedure may include an indication of how long time the UE spent in RRC_INACTIVE state, e.g., indicated as a duration or as a timestamp of the time the UE was released to RRC_INACTIVE state.

The UE may transmit information about when sessions were ongoing or not while in RRC_INACTIVE. As an example, from time a to time b, the UE had a session ongoing, from time be to time c, there was no session ongoing, from time c to time d, there was a session ongoing etc. As a simplified option, the UE may indicate the timestamp corresponding to the moment the session started and/or ended while in RRC_INACTIVE state.

The information related to one or more QoE measurement sessions may be transmitted to the first RAN node responsive further to one or more of: a configuration received from the communication network; and a type of event that triggered the user equipment to transition to the connected state.

For example, the trigger for a UE with an active application session to initiate the RRC resume procedure may typically be that the application generates uplink data to be transmitted (e.g. a request to an application server, e.g. a request for streaming data). In another option, the trigger for the RRC resume procedure may be that a buffer for an application session has emptied or has fallen below a certain threshold, or it exhibits a decreasing trend. In another option, the trigger may be a paging message from the network. The paging message may be triggered by downlink application data pending to be transmitted to the UE. In the case of a UE in RRC_INACTIVE state, the UE may be paged through RAN paging and reception of the page will trigger the UE to initiate the RRC resume procedure to transit to RRC_CONNECTED state. In the case of a UE in RRC_IDLE state (which may be relevant in the context of this disclosure, particularly if future 3GPP releases enable a UE to retain a QoE configuration in RRC_IDLE state), the UE may be paged through CN paging and reception of the page will trigger the UE to initiate the RRC setup procedure to transit to RRC_CONNECTED state. The decision to provide session status information from the UE to the new RAN node, and/or what information to provide, may depend on the nature of the trigger of the RRC resume (or RRC setup) procedure, which will be further explained below in conjunction with the description of configuration.

In one option, the UE may also provide to the network the QoE-specific reason for initiating RRC resume, e.g., as described above (UL data to send, buffer depletion etc.).

Whether a UE should provide session status information when resuming a connection in a RAN node (or performing an RRC setup procedure after a period in RRC_IDLE state), as well as what type of information to provide, may be configured by the network.

As one option, the RAN node releasing the UE to RRC_INACTIVE state (or RRC_IDLE state) may indicate in the message releasing the UE to RRC_INACTIVE state (or RRC_IDLE state), e.g. an RRCRelease message, instructions of possible session status information reporting to be provided from the UE to the RAN node towards which the UE performs a subsequent RRC resume procedure. Such instructions may for instance indicated whether the UE should provide its session status information, whether this should be done only if the session status has changed or is different from what it was at the time when the UE is released to RRC_INACTIVE state (or RRC_IDLE state) (e.g. the session status when the UE receives the RRCRelease message), and/or what type of information the UE should provide (e.g. only the latest/current session status or a list of session status indications, and/or additional information such as the duration of the period in RRC_INACTIVE state (or RRC_IDLE state).

As another option, the RAN node towards which the UE performs the RRC resume procedure (or RRC setup procedure) may include instructions like the ones described above in the RRCResume message (or RRCSetup message).

In another option, the RAN node configures the UE to transmit session status updates in the UEAssistanceInformation message.

As yet another option, the RAN node towards which the UE performs the RRC resume procedure (or RRC setup procedure) may use a UEInformationRequest message to explicitly request the UE to send certain session status information and/or additional information in a UEInformationResponse message (possibly after the UE has indicated the availability of such information in the RRCResumeComplete message (or the RRCSetupComplete message).

As yet another option, the RAN node towards which the UE performs the RRC resume procedure (or RRC setup procedure) may use an RRCReconfigurationRequest message to explicitly request the UE to send certain session status information and/or additional information, e.g. in a MeasurementReportAppLayer message.

As yet another option, which may complement (e.g. be used in parallel with) any of the options above, if the RRC resume procedure is triggered by a page, the RAN node may include the above described type of instructions in the RRC Paging message.

As yet another option, the instructions may be indicated in broadcast system information. If this option is used, in one variant it may be used as the default instructions, which may be overridden, or complemented by instructions provided to the UE in any of the above-described ways.

The UE may be configured to transmit all updates of the session status, or it may be configured to transmit session status updates only at resume to RRC_CONNECTED only if the session status has change since the UE was transferred to RRC_INACTIVE (or RRC_IDLE).

The instructions may be unconditional, but in some variants, they may depend on one or more conditions. For example, the instructions, or parts of the instructions, may be conditioned by the type of trigger of the RRC resume procedure (or RRC setup procedure), e.g. such that the instructions depend on whether the trigger is UE internal trigger or a page.

In another option, the RAN node may configure the UE to initiate RRC resume when the session status has changed, e.g., when session starts or ends, and to provide the session information in conjunction to it.

A further condition may target the case of a UE internal trigger, e.g. such that the instructions may depend on whether the UE internal trigger is generation of application data (of an application with an associated QoE configuration for which the instructions apply) or another UE internal trigger.

A further condition may target the case of the trigger being a page, e.g. such that the instructions may depend on whether the page is a RAN initiated page or a CN initiated page.

In another example, the instructions, or parts of the instructions, may be conditioned by whether the RAN node the UE performs the RRC resume procedure (or RRC setup procedure) towards is the same as the old RAN node (i.e. the RAN node that released the UE to RRC_INACTIVE state (or RRC_IDLE state)) or another RAN node. In this example, a possible further condition could target the case where the RAN node the UE performs the RRC resume procedure (or RRC setup procedure) towards is the same as the old RAN node, e.g. such that the instructions may depend on whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by the type of state transition procedure (i.e. which state the UE is leaving to enter RRC_CONNECTED state), e.g. such that the instructions may depend on whether the state transition procedure is an RRC resume procedure (to let the UE transit from RRC_INACTIVE state to RRC_CONNECTED state) or an RRC setup procedure (to let the UE transit from RRC_IDLE state to RRC_CONNECTED state).

In step 904, which may be additional or alternative to step 902, upon a user equipment connecting to the first network node and transitioning to a connected state, the first RAN node receives, from a second network node of the communication network, information related to one or more quality-of-experience, QoE, measurement sessions configured at the user equipment. The second RAN node may be the RAN node that the UE was previously connected to (e.g., when released to the inactive or idle state). Note that, where the first RAN node is the same RAN node that the UE was previously connected to (e.g., when released to the inactive or idle mode), step 902 does not apply.

The information provided by the second RAN node may include any and all of the information set out above with respect to step 902. However, note that the values for the parameters contained in the information may correspond to the values at the time when the UE transitioned to the idle or inactive state.

The information provided by the UE may be more up-to-date than the information provided by the second RAN node (e.g., in view of changes to the information while the UE was in the inactive or idle state). In step 906, the first RAN node therefore overwrites values for one or more parameters in information provided by the second RAN node with values for corresponding parameters provided by the UE. (Note that steps 902 and 904 may happen in any order.)

Thus, when a UE in RRC_INACTIVE state initiates an RRC resume procedure towards the new, first RAN node (e.g., gNB or eNB), the anchor (second) RAN node (e.g., gNB or eNB) may transfer the session ongoing/not ongoing status that was valid when the UE was released to RRC_INACTIVE state, but that information may be outdated and incorrect. So, this information could optionally be excluded from the UE context information that is transferred (e.g., in the RETRIEVE UE CONTEXT RESPONSE XnAP message) from the anchor RAN node to the new RAN node where the UE resumes the RRC connection, or, as another option, it may be included in the UE context transferred from the anchor RAN node to the new RAN node, but will then be overridden by the information sent from the UE. As a further option, the session status (i.e., the ongoing/not ongoing status) that was valid when the UE was released to RRC_INACTIVE state is included in the UE context information that is transferred (e.g. in the RETRIEVE UE CONTEXT RESPONSE XnAP message) from the anchor RAN node to the new RAN node where the UE resumes the RRC connection, and the UE sends overriding session status information to the new RAN node only if it is different from the session status information sent from the anchor RAN node to the new RAN node (i.e. if the session status information in the UE is different from what it was when the UE was released to RRC_INACTIVE state).

Note that although the solution embodiments described herein refer to a case where the UE performs the RRC resume procedure (or RRC setup procedure) towards another RAN node than the RAN node that released the UE to RRC_INACTIVE state (or RRC_IDLE state), the solution embodiments are applicable also when the UE performs the RRC resume procedure (or RRC setup procedure) towards the same RAN node as released the UE to RRC_INACTIVE state (or RRC_IDLE state), wherein even the cell in which the UE performs the RRC resume procedure (or RRC setup procedure) may be the same as the cell in which the UE was released to RRC_INACTIVE state (or RRC_IDLE state).

In case the UE is in dual connectivity, and in case the SN has configured the UE for QoE measurements, the SN is the node that has the knowledge about the session status. In that case, the SN informs the MN about the session status, and the MN may inform the new RAN node upon RRC resume of RRC connection establishment. To do this, the SN may use one of the existing DC-related XnAP procedures (with possible enhancements) or a newly defined procedure.

FIG. 10 depicts a method in accordance with particular embodiments. The method may be performed by a second network node (e.g. the network node 1110 or network node 1300 as described later with reference to FIGS. 11 and 13 respectively). The method of FIG. 10 may be read in conjunction with the methods of FIGS. 7 and 9, which set out corresponding steps in a UE and a first RAN node, respectively.

The method begins with a UE initially in the connected state (e.g., an RRC state such as RRC_CONNECTED), and connected to the second RAN node. The UE may be configured with one or more QoE measurement sessions associated with respective application sessions. In step 1002, the UE is released to an inactive or idle state (e.g., RRC_INACTIVE or RRC_IDLE).

In step 1004, upon a user equipment connecting to a first RAN node and transitioning to a connected state, the second network node transmits, to the first RAN node, information related to one or more QoE measurement sessions configured at the user equipment. For example, the UE may resume a connection that was previously suspended (i.e., moving from RRC_INACTIVE to RRC_CONNECTED) or establish a new connection (i.e., moving from RRC_IDLE to RRC_CONNECTED). As part of this transition, the UE connects to the first RAN node.

The information related to one or more QoE measurement sessions may comprise information related to one or more QoE measurement sessions at the time the UE was released to the inactive or idle state. Alternatively, the second RAN node may receive information from the UE while the UE is in the inactive state (see, e.g., FIG. 8 above). In this case, the information supplied to the first RAN node may correspond to the information as updated while the UE is in the inactive state.

The information related to one or more QoE measurement sessions configured at the user equipment may comprise a status of the one or more QoE measurement sessions (e.g., ongoing, not ongoing, terminated, etc). In one embodiment, the information may comprise the status of only those QoE measurement sessions that are ongoing. In such embodiments, the information may comprise a list of identities for the QoE measurement sessions, and the status itself (i.e., “ongoing”) may be implicit.

The information related to one or more QoE measurement sessions may additionally or alternatively comprise one or more of: an indication of an amount of time that the user equipment was in an inactive or idle state before transitioning to the connected state; and an indication of when or how long one or more QoE measurement sessions were ongoing or not while the user equipment was in an inactive or idle state.

Thus, further information that may be provided to the first RAN node may include an indication of how long time the UE spent in RRC_INACTIVE state, e.g., indicated as a duration or as a timestamp of the time the UE was released to RRC_INACTIVE state.

The second RAN node may transmit information about when sessions were ongoing or not while in RRC_INACTIVE. As an example, from time a to time b, the UE had a session ongoing, from time be to time c, there was no session ongoing, from time c to time d, there was a session ongoing etc. As a simplified option, the second RAN node may indicate the timestamp corresponding to the moment the session started and/or ended while in RRC_INACTIVE state.

The second RAN node may configure the UE as to the circumstances (e.g., triggers for transmitting the information, the type of information that should be transmitted, etc) under which the UE should itself transmit information related to one or more QoE measurement sessions to the first RAN node.

For example, the trigger for a UE with an active application session to initiate the RRC resume procedure may typically be that the application generates uplink data to be transmitted (e.g. a request to an application server, e.g. a request for streaming data). In another option, the trigger for the RRC resume procedure may be that a buffer for an application session has emptied or has fallen below a certain threshold, or it exhibits a decreasing trend. In another option, the trigger may be a paging message from the network. The paging message may be triggered by downlink application data pending to be transmitted to the UE. In the case of a UE in RRC_INACTIVE state, the UE may be paged through RAN paging and reception of the page will trigger the UE to initiate the RRC resume procedure to transit to RRC_CONNECTED state. In the case of a UE in RRC_IDLE state (which may be relevant in the context of this disclosure, particularly if future 3GPP releases enable a UE to retain a QoE configuration in RRC_IDLE state), the UE may be paged through CN paging and reception of the page will trigger the UE to initiate the RRC setup procedure to transit to RRC_CONNECTED state. The decision to provide session status information from the UE to the new RAN node, and/or what information to provide, may depend on the nature of the trigger of the RRC resume (or RRC setup) procedure, which will be further explained below in conjunction with the description of configuration.

In one option, the UE may also provide to the network the QoE-specific reason for initiating RRC resume, e.g., as described above (UL data to send, buffer depletion etc.).

Whether a UE should provide session status information when resuming a connection in a RAN node (or performing an RRC setup procedure after a period in RRC_IDLE state), as well as what type of information to provide, may be configured by the network.

As one option, the second RAN node releasing the UE to RRC_INACTIVE state (or RRC_IDLE state) in step 1002 may indicate in the message releasing the UE to RRC_INACTIVE state (or RRC_IDLE state), e.g. an RRCRelease message, instructions of possible session status information reporting to be provided from the UE to the RAN node towards which the UE performs a subsequent RRC resume procedure. Such instructions may for instance indicate whether the UE should provide its session status information, whether this should be done only if the session status has changed or is different from what it was at the time when the UE is released to RRC_INACTIVE state (or RRC_IDLE state) (e.g. the session status when the UE receives the RRCRelease message), and/or what type of information the UE should provide (e.g. only the latest/current session status or a list of session status indications, and/or additional information such as the duration of the period in RRC_INACTIVE state (or RRC_IDLE state).

As yet another option, the instructions may be indicated in broadcast system information. If this option is used, in one variant it may be used as the default instructions, which may be overridden, or complemented by instructions provided to the UE in any of the above-described ways.

The UE may be configured to transmit all updates of the session status, or it may be configured to transmit session status updates only at resume to RRC_CONNECTED only if the session status has change since the UE was transferred to RRC_INACTIVE (or RRC_IDLE).

The instructions may be unconditional, but in some variants, they may depend on one or more conditions. For example, the instructions, or parts of the instructions, may be conditioned by the type of trigger of the RRC resume procedure (or RRC setup procedure), e.g. such that the instructions depend on whether the trigger is UE internal trigger or a page.

In another option, the second RAN node may configure the UE to initiate RRC resume when the session status has changed, e.g., when session starts or ends, and to provide the session information in conjunction to it.

A further condition may target the case of a UE internal trigger, e.g. such that the instructions may depend on whether the UE internal trigger is generation of application data (of an application with an associated QoE configuration for which the instructions apply) or another UE internal trigger.

A further condition may target the case of the trigger being a page, e.g. such that the instructions may depend on whether the page is a RAN initiated page or a CN initiated page.

In another example, the instructions, or parts of the instructions, may be conditioned by whether the first RAN node is the same as the second RAN node or a different RAN node. In this example, a possible further condition could target the case where the RAN node the UE performs the RRC resume procedure (or RRC setup procedure) towards is the same as the old RAN node, e.g. such that the instructions may depend on whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by whether the cell the UE performs the RRC resume procedure (or RRC setup procedure) in is the same as the cell in which the UE was released to RRC_INACTIVE state (or RRC_IDLE state) or another cell.

In another example, the instructions, or parts of the instructions, may be conditioned by the type of state transition procedure (i.e. which state the UE is leaving to enter RRC_CONNECTED state), e.g. such that the instructions may depend on whether the state transition procedure is an RRC resume procedure (to let the UE transit from RRC_INACTIVE state to RRC_CONNECTED state) or an RRC setup procedure (to let the UE transit from RRC_IDLE state to RRC_CONNECTED state).

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3^{rd} Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 11, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, a content source and analytics node, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs). The processing circuitry 1202 may be operable to provide, either alone or in conjunction with other UE 1200 components, such as the memory 1210, UE 1200 functionality. For example, the processing circuitry 1202 may be configured to cause the UE 1202 to perform the methods as described with reference to FIGS. 7 and/or 8.

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In some embodiments, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, a memory 1304, a communication interface 1306, and a power source 1308, and/or any other component, or any combination thereof. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, network node 1300 functionality. For example, the processing circuitry 1302 may be configured to cause the network node to perform the methods as described with reference to FIGS. 9 and/or 10.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the data rate, latency, power consumption etc., of a UE and/or network node and thereby provide benefits such as reduced user waiting time, relaxed restriction on file size, improved content resolution, better responsiveness, extended battery lifetime etc.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

For the avoidance of doubt, the following numbered statements set out embodiments of the disclosure:

### Group A Embodiments

1. A method performed by a user equipment, the method comprising:
upon transitioning to a connected state:
connecting to a first radio access network, RAN, node of a communication network; and
transmitting, to the communication network, information related to one or more quality-of-experience, QoE, measurement sessions configured at the user equipment.

2. The method of embodiment 1, wherein the one or more QoE measurement sessions were configured at the user equipment by the first RAN node or a second RAN node of the communication network.

3. The method of embodiment 1 or 2, wherein the one or more QoE measurement sessions were configured at the user equipment during a previous instance of the user equipment in the connected state.

4. The method of any one of embodiment 3, wherein the information related to one or more QoE measurement sessions comprises values for one or more parameters that have changed since the user equipment transitioned from the previous instance of being in the connected state to an inactive state or an idle state.

5. The method of any one of the preceding embodiments, wherein transitioning to the connected state comprises one of: resuming a connection from an inactive state; and establishing a connection from an idle state.

6. The method of any one of the preceding embodiments, wherein the information related to one or more QoE measurement sessions configured at the user equipment comprises a status of the one or more QoE measurement sessions.

7. The method of embodiment 6, wherein the status of a QoE measurement session comprises one of: ongoing; not ongoing; and terminated.

8. The method of any one of the preceding embodiments, wherein the information related to one or more QoE measurement sessions configured at the user equipment comprises one or more of: an indication of an amount of time that the user equipment was in an inactive or idle state before transitioning to the connected state; and an indication of when or how long one or more QoE measurement sessions were ongoing or not while the user equipment was in an inactive or idle state.

9. The method of any one of the preceding embodiments, wherein the information related to one or more QoE measurement sessions configured at the user equipment comprises information for one or more QoE measurement sessions that are ongoing.

10. The method of any one of the preceding embodiments, wherein the information related to one or more QoE measurement sessions is transmitted to the first RAN node in a connection resume request message or a connection establishment request message.

11. The method of any one of embodiments 1 to 9, wherein the information related to one or more QoE measurement sessions is transmitted to the first RAN node in a message confirming establishment of a connection to the first RAN node or resumption of a connection with the first RAN node.

12. The method of any one of embodiments 1 to 9, wherein the information related to one or more QoE measurement sessions is transmitted to the first RAN node in response to a request message received from the first RAN node.

13. The method of any one of the preceding embodiments, wherein the information related to one or more QoE measurement sessions is transmitted to the first RAN node responsive further to one or more of: a configuration received from the communication network; and a type of event that triggered the user equipment to transition to the connected state.

14. A method performed by a user equipment, the method comprising:
while in an inactive connectivity state:
transmitting to a first radio access network, RAN, node of a communication network, information related to one or more quality-of-experience, QoE, measurement sessions configured at the user equipment.

15. The method of embodiment 14, wherein the information related to one or more QoE measurement sessions is transmitted to the first RAN node by means of one or more small data transmissions.

16. The method of embodiment 14 or 15, wherein the information related to one or more QoE measurement sessions configured at the user equipment comprises a status of the one or more QoE measurement sessions.

17. The method of embodiment 16, wherein the status of a QoE measurement session comprises one of: ongoing; not ongoing; and terminated.

18. The method of any one of embodiments 14 to 17, wherein the user equipment was released to the inactive connectivity state by the first RAN node.

19. The method of any one of embodiments 14 to 18, wherein the information related to one or more QoE measurement sessions is transmitted responsive to one or more of: a QoE measurement session that was ongoing when the user equipment was released to the inactive connectivity state ending successfully; a QoE measurement session that was ongoing when the user equipment was released to the inactive connectivity state ending unsuccessfully; a new application session starting; one or more changes in a status of an application session that was ongoing when the user equipment was released to the inactive connectivity state; one or more changes in a status of an application session that started after the user equipment was released to the inactive connectivity state; a timer has expired or is running; the user equipment has reselected a new cell; data volume is below a threshold.

20. The method of any of the previous embodiments, further comprising:
providing user data; and
forwarding the user data to a host via the transmission to the network node.

### Group B Embodiments

21. A method performed by a first network node of a communication network, the method comprising:
upon a user equipment connecting to the first network node and transitioning to a connected state,
   receiving, from one or more of the user equipment and a second network node of the communication network, information related to one or more quality-of-experience, QoE, measurement sessions configured at the user equipment.

22. The method of embodiment 21, wherein the one or more QoE measurement sessions were configured at the user equipment by the first network node or the second network node of the communication network.

23. The method of embodiment 21 or 22, wherein the one or more QoE measurement sessions were configured at the user equipment during a previous instance of the user equipment in the connected state.

24. The method of any one of embodiment 23, wherein the information related to one or more QoE measurement sessions is received from the user equipment and comprises values for one or more parameters that have changed since the user equipment transitioned from the previous instance of being in the connected state to an inactive state or an idle state.

25. The method of embodiment 24, wherein the information related to one or more QoE measurement sessions is received from the user equipment and the second network node, and wherein information received from the second network node is overwritten by information received from the user equipment.

26. The method of any one of embodiments 21 to 25, wherein the user equipment transitioning to the connected state comprises one of: resuming a connection from an inactive state; and establishing a connection from an idle state.

27. The method of any one of embodiments 21 to 26, wherein the information related to one or more QoE measurement sessions configured at the user equipment comprises a status of the one or more QoE measurement sessions.

28. The method of embodiment 27, wherein the status of a QoE measurement session comprises one of: ongoing; not ongoing; and terminated.

29. The method of any one of embodiments 21 to 28, wherein the information related to one or more QoE measurement sessions configured at the user equipment comprises one or more of: an indication of an amount of time that the user equipment was in an inactive or idle state before transitioning to the connected state; and an indication of when or how long one or more QoE measurement sessions were ongoing or not while the user equipment was in an inactive or idle state.

30. The method of any one of embodiments 21 to 29, wherein the information related to one or more QoE measurement sessions configured at the user equipment comprises information for one or more QoE measurement sessions that are ongoing.

31. The method of any one of embodiments 21 to 30, wherein the information related to one or more QoE measurement sessions is received from the user equipment in a connection resume request message or a connection establishment request message.

32. The method of any one of embodiments 21 to 30, wherein the information related to one or more QoE measurement sessions is received from the user equipment in a message confirming establishment of a connection to the first network node or resumption of a connection with the first network node.

33. The method of any one of embodiments 21 to 30, wherein the information related to one or more QoE measurement sessions is received from the user equipment in response to a request message transmitted to the user equipment by the first network node.

34. The method of any one of embodiments 21 to 33, wherein the information related to one or more QoE measurement sessions is received from the user equipment responsive further to one or more of: a configuration of the user equipment by the communication network; and a type of event that triggered the user equipment to transition to the connected state.

35. A method performed by a second network node, the second network node serving a user equipment which is released to an inactive or idle connectivity state, the method comprising:
transmitting, to a first network node to which the user equipment has subsequently connected upon transitioning to a connected state, information related to one or more quality-of-experience, QoE, measurement sessions configured at the user equipment.

36. The method of embodiment 35, wherein the information related to one or more QoE measurement sessions configured at the user equipment comprises a status of the one or more QoE measurement sessions.

37. The method of embodiment 36, wherein the status of a QoE measurement session comprises one of: ongoing; not ongoing; and terminated.

38. The method of any one of embodiments 35 to 37, wherein the information related to one or more QoE measurement sessions configured at the user equipment comprises one or more of: an indication of an amount of time that the user equipment was in an inactive or idle state before transitioning to the connected state; an indication of a time that the user equipment was released to the inactive or idle connectivity state; an indication of final values for one or more QoE parameters reported to the second network node before the user equipment was released to the inactive or idle connectivity state; and an indication of when or how long one or more QoE measurement sessions were ongoing or not while the user equipment was in an inactive or idle state.

39. The method of any one of embodiments 35 to 38, wherein the information related to one or more QoE measurement sessions configured at the user equipment comprises information for one or more QoE measurement sessions that are ongoing.

40. The method of any of the previous embodiments, further comprising:
obtaining user data; and
forwarding the user data to a host or a user equipment.

### Group C Embodiments

41. A user equipment, comprising:
processing circuitry configured to cause the user equipment to perform any of the steps of any of the Group A embodiments; and
power supply circuitry configured to supply power to the processing circuitry.

42. A network node, the network node comprising:
processing circuitry configured to cause the network node to perform any of the steps of any of the Group B embodiments;
power supply circuitry configured to supply power to the processing circuitry.

43. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

44. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

45. The host of the previous embodiment, wherein the cellular network further includes a network node configured to communicate with the UE to transmit the user data to the UE from the host.

46. The host of the previous 2 embodiments, wherein:
the processing circuitry of the host is configured to execute a host application, thereby providing the user data; and
the host application is configured to interact with a client application executing on the UE, the client application being associated with the host application.

47. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

48. The method of the previous embodiment, further comprising:
at the host, executing a host application associated with a client application executing on the UE to receive the user data from the UE.

49. The method of the previous embodiment, further comprising:
at the host, transmitting input data to the client application executing on the UE, the input data being provided by executing the host application,
wherein the user data is provided by the client application in response to the input data from the host application.

50. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

51. The host of the previous embodiment, wherein the cellular network further includes a network node configured to communicate with the UE to transmit the user data from the UE to the host.

52. The host of the previous 2 embodiments, wherein:
the processing circuitry of the host is configured to execute a host application, thereby providing the user data; and
the host application is configured to interact with a client application executing on the UE, the client application being associated with the host application.

53. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

54. The method of the previous embodiment, further comprising:
at the host, executing a host application associated with a client application executing on the UE to receive the user data from the UE.

55. The method of the previous embodiment, further comprising:
at the host, transmitting input data to the client application executing on the UE, the input data being provided by executing the host application,
wherein the user data is provided by the client application in response to the input data from the host application.

56. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

57. The host of the previous embodiment, wherein:
the processing circuitry of the host is configured to execute a host application that provides the user data; and
the UE comprises processing circuitry configured to execute a client application associated with the host application to receive the transmission of user data from the host.

58. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

59. The method of the previous embodiment, further comprising, at the network node, transmitting the user data provided by the host for the UE.

60. The method of any of the previous 2 embodiments, wherein the user data is provided at the host by executing a host application that interacts with a client application executing on the UE, the client application being associated with the host application.

61. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

62. The communication system of the previous embodiment, further comprising:
the network node; and/or
the user equipment.

63. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

64. The host of the previous embodiment, wherein:
the processing circuitry of the host is configured to execute a host application, thereby providing the user data; and
the host application is configured to interact with a client application executing on the UE, the client application being associated with the host application.

65. The host of the any of the previous 2 embodiments, wherein the initiating receipt of the user data comprises requesting the user data.

66. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

67. The method of the previous embodiment, further comprising at the network node, transmitting the received user data to the host.

1-40. (canceled)

41. A method performed by a user equipment, the method comprising:
upon transitioning to a connected state:
connecting to a first radio access network (RAN) node of a communication network; and
transmitting, to the communication network, information related to one or more quality-of-experience (QoE) measurement sessions configured at the user equipment,
wherein the one or more QoE measurement sessions were configured at the user equipment during a previous instance of the user equipment in the connected state.

42. The method of claim 41, wherein the one or more QoE measurement sessions were configured at the user equipment by the first RAN node or a second RAN node of the communication network.

43. The method of claim 41, wherein the information related to one or more QoE measurement sessions comprises values for one or more parameters that have changed since the user equipment transitioned from the previous instance of being in the connected state to an inactive state or an idle state.

44. The method of claim 41, wherein transitioning to the connected state comprises one of: resuming a connection from an inactive state; and establishing a connection from an idle state.

45. The method of claim 41, wherein the information related to one or more QoE measurement sessions configured at the user equipment comprises a status of the one or more QoE measurement sessions.

46. The method of claim 45, wherein the status of a QoE measurement session comprises one of: ongoing; not ongoing; and terminated.

47. The method of claim 41, wherein the information related to one or more QoE measurement sessions configured at the user equipment comprises one or more of: an indication of an amount of time that the user equipment was in an inactive or idle state before transitioning to the connected state; and an indication of when or how long one or more QoE measurement sessions were ongoing or not while the user equipment was In an inactive or idle state.

48. The method of claim 41, wherein the information related to one or more QoE measurement sessions configured at the user equipment comprises information for one or more QoE measurement sessions that are ongoing.

49. The method of claim 41, wherein the information related to one or more QoE measurement sessions is transmitted to the first RAN node:
in a connection resume request message or a connection establishment request message;
in a message confirming establishment of a connection to the first RAN node or resumption of a connection with the first RAN node; or
in response to a request message received from the first RAN node.

50. The method of claim 41, wherein the information related to one or more QoE measurement sessions is transmitted to the first RAN node responsive further to one or more of: a configuration received from the communication network; and a type of trigger for transitioning the user equipment from an inactive state or an idle state to the connected state.

51. A method performed by a first network node of a communication network, the method comprising:
upon a user equipment connecting to the first network node and transitioning to a connected state,
receiving, from one or more of the user equipment and a second network node of the communication network, information related to one or more quality-of-experience (QoE) measurement sessions configured at the user equipment, wherein the one or more QoE measurement sessions were configured at the user equipment during a previous instance of the user equipment in the connected state.

52. The method of claim 51, wherein the one or more QoE measurement sessions were configured at the user equipment by the first network node or the second network node of the communication network.

53. The method of claim 51, wherein the information related to one or more QoE measurement sessions is received from the user equipment and comprises values for one or more parameters that have changed since the user equipment transitioned from the previous instance of being in the connected state to an inactive state or an idle state.

54. The method of claim 53, wherein the information related to one or more QoE measurement sessions is received from the user equipment and the second network node, and wherein information received from the second network node is overwritten by information received from the user equipment.

55. The method of claim 51, wherein the user equipment transitioning to the connected state comprises one of: resuming a connection from an inactive state; and establishing a connection from an idle state.

56. The method of claim 51, wherein the information related to one or more QoE measurement sessions configured at the user equipment comprises a status of the one or more QoE measurement sessions.

57. The method of claim 56, wherein the status of a QoE measurement session comprises one of: ongoing; not ongoing; and terminated.

58. A method performed by a second network node, the second network node serving a user equipment which is released to an inactive or idle connectivity state, the method comprising:
transmitting, to a first network node to which the user equipment has subsequently connected upon transitioning to a connected state, information related to one or more quality-of-experience (QoE) measurement sessions configured at the user equipment.

59. The method of claim 58, wherein the information related to one or more QoE measurement sessions configured at the user equipment comprises a status of the one or more QoE measurement sessions.

60. The method of claim 59, wherein the status of a QoE measurement session comprises one of: ongoing; not ongoing; and terminated.

61. A user equipment, comprising:
processing circuitry configured to cause the user equipment to:
upon transitioning to a connected state:
connect to a first radio access network (RAN) node of a communication network; and
transmit, to the communication network, information related to one or more quality-of-experience (QoE) measurement sessions configured at the user equipment, wherein the one or more QoE measurement sessions were configured at the user equipment during a previous instance of the user equipment in the connected state; and
power supply circuitry configured to supply power to the processing circuitry.

62. The user equipment according to claim 61, wherein the one or more QoE measurement sessions were configured at the user equipment by the first RAN node or a second RAN node of the communication network.

63. A first network node, the first network node comprising:
processing circuitry configured to cause the network node to:
upon a user equipment connecting to the first network node and transitioning to a connected state,
receive, from one or more of the user equipment and a second network node of the communication network, information related to one or more quality-of-experience (QoE) measurement sessions configured at the user equipment, wherein the one or more QoE measurement sessions were configured at the user equipment during a previous instance of the user equipment in the connected state; and
power supply circuitry configured to supply power to the processing circuitry.

64. The first network node according to claim 63, wherein the information related to one or more QoE measurement sessions is received from the user equipment and comprises values for one or more parameters that have changed since the user equipment transitioned from the previous instance of being in the connected state to an inactive state or an idle state.

65. A second network node, the second network node serving a user equipment which is released to an inactive or idle connectivity state, the second network node comprising:
processing circuitry configured to cause the second network node to:
transmit, to a first network node to which the user equipment has subsequently connected upon transitioning to a connected state, information related to one or more quality-of-experience (QoE) measurement sessions configured at the user equipment; and
power supply circuitry configured to supply power to the processing circuitry.

66. The second network node according to claim 65, wherein the information related to one or more QoE measurement sessions configured at the user equipment comprises a status of the one or more QoE measurement sessions.
